(19) United States
(12) Patent Application Publication
(10) Pub. No.: US 2024/0417525 A1
(43) Pub. Date: Dec. 19, 2024

(54) DISCONTINUOUS SOFT MATTER PHASE TRANSITIONS FROM ORDER-DISORDER TRANSITIONS

(71) Applicant: The Government of the United States of America, as represented by the Secretary of the Navy, Arlington, VA (US)

(72) Inventors: Bernard R. Matis, Alexandria, VA (US); Steven W. Liskey, Berline, MD (US); Nicholas T. Gangemi, Washington, DC (US); Aaron D. Edmonds, Alexandria, VA (US); William B. Wilson, Pasadena, MD (US); Jeffrey W. Baldwin, Fairfax, VA (US); Douglas M. Photiadis, McDaniel, MD (US)

(73) Assignee: The Government of the United States of America, as represented by the Secretary of the Navy, Arlington, VA (US)

(21) Appl. No.: 18/745,067

(22) Filed: Jun. 17, 2024

Related U.S. Application Data
(60) Provisional application No. 63/508,640, filed on Jun. 16, 2023.

(51) Int. Cl. C08J 9/16; C08J 3/075

(52) U.S. Cl. CPC C08J 9/16; C08J 3/075; C08J 2333/20

(57) ABSTRACT

Disclosed herein is a composition having: a soft material having a shear modulus and a bulk modulus larger than the shear modulus and a plurality of encapsulated microbubbles within the soft material. The composition exhibits a discontinuous change in an acoustic property relative to an applied frequency. The composition may be used for wearable sensors, micromachines, medical devices, and metamaterials.

### REFERENCE TO RELATED APPLICATIONS

This application claims the benefit of U.S. Provisional Application No. 63/508,640, filed on Jun. 16, 2023. The provisional application and all other publications and patent documents referred to throughout this nonprovisional application are incorporated herein by reference.

### TECHNICAL FIELD

The present disclosure is generally related to materials have discontinuous acoustic properties.

### DESCRIPTION OF THE RELATED ART

Doping soft materials with compliant, sub-wavelength impurities (including micron-scale impurities with nano-scale features) has been shown to be a controllable and scalable path forward for tailoring a material's bulk effective ultrasonic properties [1-3]. Studies on doping soft media with non-resonant impurities have demonstrated the ability to continuously manipulate physical parameters like the acoustic index [1], wave speed (longitudinal and shear), effective bulk modulus, and the frequency-dependent attenuation coefficient [2,3]. The ability to manipulate these properties is important for realizing novel acoustic materials, and for applications ranging from wearable sensors [4-6] to micromachines [7-9], medical devices [10, 11], and metamaterials [12-14].

To study impurity-induced physics in soft materials, researchers often use hydrogels as a starting platform because gels are a model system affording long-term impurity suspension, a high acoustic impedance contrast with the impurities and a low acoustic impedance contrast with the surrounding environment (e.g., water), and negligible intrinsic loss [1,15-17]. Studies focusing on hydrogels doped with resonant impurities have shown large changes in the phase, group, and energy velocities, and have demonstrated conversion between coherent and incoherent energies within a strongly scattering regime (the mean free path IS comparable to the wavelength), which are due to Mie scattering and the shifted Minnaert resonance for encapsulated microbubbles [16,17]. Equally important is these studies focus on dilute emulsions with impurity volume fractions of only a few percent, which is beneficial to the controlled fabrication of viscoelastic materials using pressure injection methods that rely on minimal changes in viscosity with the impurity addition [2]. Nevertheless, doping with resonant impurities generally leads to continuously tunable properties similar to doping with non-resonant impurities, and the resultant properties generally do not exhibit any discontinuous phase change behavior [2, 3, 15, 16].

However, recent measurements of ultrasound propagation through a suspending gel doped with gas-filled encapsulated microbubbles with a broad size (and therefore resonance frequency) distribution demonstrated a discontinuous change in sound speed (by a factor 2.5) at a critical excitation frequency [17]; moreover, broadband behavior (100's kHz) was observed on either side of the critical frequency. Such discontinuous sound speed behavior disagrees with a simple mixture model (the so-called Wood's model where

$$v = {[ ( Φ {ρ}_{fluid} + ( 1 - Φ ) {ρ}_{gas} ) ( Φ {β}_{fluid} + ( 1 - Φ ) {β}_{gas} ) ]}^{- \frac{1}{2}}$$

where v is the sound speed, Φ the fluid volume fraction, ρ the density, and β the compressibility), and also disagrees with multiple scattering models that predict a smoothly varying sound speed with changing dopant volume fraction [2,3]. Nevertheless, the discontinuous transition was not the primary focus of the previous work, and so the encapsulated microbubble volume fraction dependence of the observed discontinuous behavior, as well as the underlying physics, are still unknown. Gaining an understanding of such discontinuous behavior is important as hydrogels have received much attention owing to their ability, in part, to be used as building blocks in wearable sensors [4], reversible switches [19], and for their potential use in implantable microdevices with moving parts [7,8]. In this regard, the ability to remotely induce an abrupt transition within a gel's properties could serve as a key component in such systems if the transition could be used as an actuator for moving parts or lead to switch-like behavior in material properties.

### SUMMARY OF THE INVENTION

Disclosed herein is a composition comprising: a soft material having a shear modulus and a bulk modulus larger than the shear modulus and a plurality of encapsulated microbubbles within the soft material. The composition exhibits a discontinuous change in an acoustic property relative to an applied frequency.

### BRIEF DESCRIPTION OF DRAWINGS

A more complete appreciation will be readily obtained by reference to the following Description of the Example Embodiments and the accompanying drawings.

FIG. 1 shows an undoped gel image.

FIG. 2 shows an image of the gel doped to an encapsulated microbubble (EMB) equilibrium volume fraction ϕ=2.41%±0.05%, which was fabricated in the same manner as those gels for which data is presented.

FIG. 3 shows the EMB size distribution. EMB count (in percent) versus equilibrium diameter D_{O} determined with optical microscopy as presented in Ref. 17, and presented here with additional D_{O} and EMB resonance frequency f_{O} information as well as a Gaussian fit to the distribution (solid line). The y-axis percentage reflects the number of EMBs at each D_{O} out of the total number of measured EMBs. Indicated is the DO range, and the corresponding f_{O} range, targeted by the experiments. Note the experimental frequency range is 50-800 kHz, which extends to frequencies well below the lowest f_{O} in the distribution.

FIG. 4 shows predicted encapsulated microbubble (EMB) resonance frequency f_{O} versus equilibrium diameter D_{O} indicating the broad overlap (starting at ˜360 kHz) between the experimental frequency range (50-800 kHz) and the f_{O} range afforded by the distribution shown in FIG. 3. The solid arrows indicate the same frequencies shown in the FIG. 3.

FIG. 5 shows predicted EMB scattering cross section σ(f) versus frequency f for an equilibrium diameter D_{O}=90 μm, which is normalized to the equilibrium cross section πR_{O}² where R_{O} is the EMB equilibrium radius. The prediction accounts for acoustic radiation damping. On resonance, the effective scattering cross section is several orders of magnitude larger than the EMB equilibrium geometrical cross section. Inset: damping coefficient β as a function of f for damping from acoustic radiation, EMB shell viscosity, and thermal effects; damping is primarily due to acoustic radiation within the frequency range of interest (400-800 kHz).

FIG. 6 shows the Uralite polymer shell into which the gel is poured for the in-water measurements. The center ports are sealed input/output through which the gel is injected. The top corner tabs are suspended from 0.6 mm diameter monofilament nylon line and the bottom corner tabs are weighted with two 63 g lead sinkers with a maximum dimension of 25.5 mm.

FIG. 7 shows a sample cross-sectional side view showing the material thicknesses: L_{G} and L_{U} for the gel and Uralite layers, respectively, and the experimental setup showing the relative source, sample, and hydrophone positions for the in-water transmission measurements.

FIG. 8 shows water sound speed versus temperature T measured for two separate runs (solid circles and open squares, respectively) using the experimental setup shown in the FIG. 7. The sound speed is determined through a time-of-flight measurement for a 1 microsecond-wide impulse, and confirmed with a wavepacket similar to the one shown in the FIG. 10. The dashed line is the standard published temperature-dependent sound speed profile for distilled water [41].

FIG. 9 shows measured pressure P versus time t for the incident wavepacket (no sample, solid line) and for transmission though the sample with an EMB equilibrium volume fraction ϕ=1.58% (dashed line). Inset: sound level SL frequency f spectrum for the incident wavepacket obtained during the water reference (no sample) measurement.

FIG. 10 shows measured scattering mean free path l_{S} versus f for the two doped samples with the lowest ϕ discussed (upper curve: ϕ=0.21%, lower curve: ϕ=0.81%). The dashed line is a reference for the doped gel thickness L_{G}=10 mm.

FIG. 11 shows the density of active oscillators ρ_{active} versus f for the sample with ϕ=0.21%.

FIGS. 12-14 show frequency spectra for the ratio of l_{S} to the effective wavelength λ for three representative samples with different ϕ. For clarity, error bars (determined from uncertainties in the measured sound level and doped gel thickness) are shown for every 5th data point. The dashed line is a reference to l_{S}/λ=1. In each figure part, f_{C}* is the critical frequency at which a discontinuous transition is observed between wave propagation regimes (i.e., a transition between fluid-like and gaseous-like behavior). Also, in each figure part the horizontal axes are plotted over the EMB resonance frequency range targeted by the experiment.

FIG. 15 shows measured change in phase angle Δθ versus frequency f for an EMB equilibrium volume fraction ϕ=1.58%. The shaded region highlights the frequency range over which the measured l_{S}/λ<1 where l_{S} and λ are the scattering mean free path and effective wavelength, respectively (compare to FIG. 12); outside the shaded gray region, measured l_{S}/λ>1. The dashed lines are linear fits to the data from which the slope of Δθ versus f (and therefore phase velocity v_{L} versus f) on either side of the critical frequency f_{C}* is determined.

FIG. 16 shows measured change in phase angle Δθ versus frequency f for an EMB equilibrium volume fraction ϕ=1.58%. The solid circle data set is the same data set shown in FIG. 15. The solid line data set corresponds to the same data, but with an additional 182 μs of time added onto the time-windowed data following the wavepacket arrival. The agreement between the two data sets indicates the results are not a result of insufficient data or signal processing.

FIG. 17 shows Δθ versus f for varying EMB equilibrium volume fraction ϕ. The ϕ=1.58% data set is the same solid circle data set shown in FIG. 15. In each figure part, the horizontal axes are plotted over the EMB resonance frequency range targeted by the experiment. Also, in each figure part, f_{C}* is the critical frequency at which the Δθ slope markedly changes and the random-like nature of Δθ versus f, which is most apparent when l_{S}/λ<1, becomes smooth.

FIG. 18 shows phase velocity v_{L} versus EMB equilibrium volume fraction ϕ for f=450 kHz. At various ϕ data for multiple independent speckle measurements are provided. The dashed line is a fit to v_{L}(ϕ)=ae^{-ϕ/b}+v₀ where a=926 m/s, b=3.39%, and v_{O}=370 m/s.

FIG. 19 shows phase velocity v_{L} versus EMB equilibrium volume fraction ϕ for f=750 kHz. At various ϕ data for multiple independent speckle measurements are provided. All v_{L}<750 m/s correspond to the gaseous-like phase, and the dashed line corresponds to v_{L}=456 m/s, which is the average value of all data points for the gaseous-like phase where v_{L}<750 m/s.

FIG. 20 shows power law behavior of the critical excitation frequency f_{C}* on EMB equilibrium volume fraction ϕ. The errors in f_{C}* and ϕ are comparable to the solid black circle diameter. The dashed line is a fit to y=y_{O}+mx^{b} where y_{O}, m, and b are fitting parameters.

FIG. 21 shows longitudinal phase velocity v_{L} at the lower frequency where l_{S}/λ=1 plotted versus ϕ (this frequency is determined by inspection of the l_{S}/λ frequency spectra like those shown in FIGS. 12-14). The lower dashed line is a linear fit to the data for ϕ<2.0%. The upper dashed line is a reference for the undoped sample's measured v_{L}=1,498 m/s.

FIG. 22 shows scattering mean free path IS at the lower frequency where l_{S}/λ=1 plotted versus ϕ. The dashed line is a reference for the doped gel thickness L_{G}=10 mm.

FIG. 23 shows the frequency where l_{S}/λ=1 plotted versus ϕ. The solid square data points correspond to samples studied in Ref. 17 (measured within the temperature T=296-298 K range) while the solid circle data points correspond to the samples studied in this work (measured within the T=297-299 K range). The dashed line is a linear fit with the fitting performed over the five data points with the lowest ϕ uncertainty (solid circles).

FIG. 24 shows density of states n, versus excitation frequency f for five different EMB equilibrium volume fractions ϕ for which data is presented. For each data set, the vertical dashed line indicates the critical frequency f_{C}* at which a transition is observed between fluid-like and gaseous-like behavior.

FIG. 25 shows the ultrasonic phase diagram showing the binary transition between acoustic fluid-like and quasi-gaseous regimes. The diagram plots frequency f versus encapsulated microbubble (EMB) equilibrium volume fraction ϕ. The critical excitation frequency f_{C}* at which the discontinuous transition is observed, plotted as open squares, are the same data points shown in FIG. 20 while the upper dashed line is the same fit shown in FIG. 20. The solid circles represent the lower frequency where l_{S}/λ=1, and are the same data points shown in FIG. 23. The middle dashed line is the same linear fit shown in FIG. 23. The shaded region between these dashed lines indicates the f and ϕ range over which l_{S}/λ<1 where l_{S} and λ are the scattering mean free path and effective wavelength, respectively, as well as effects of wave localization. The lower shaded region highlights the acoustic fluid (gel) phase, which can be expressed as 100%−ϕ_{eff}% for increasing frequency where ϕ_{eff} is the EMB on-resonance effective volume fraction. The upper shaded region indicates the quasi-gaseous phase (f>f_{C}*). The lower dashed line is a reference for the minimum EMB resonance frequency f_{O}˜360 kHz. For 360 kHz<f<f_{C} diffusive wave propagation is observed (not indicated).

FIG. 26 shows the density of states n_{ω} versus the square of the resonance angular frequency ω_{O} for five different EMB equilibrium volume fractions ϕ for which data is presented. Note the n_{ω} versus ω_{O}² distribution is non-Gaussian while the EMB size distribution shown in FIG. 3 is Gaussian.

FIG. 27 shows frequency spectra for the EMB equilibrium diameter D_{O} (solid circles, left vertical axis) and viscous penetration depth δ (dashed line, right vertical axis).

FIG. 28 shows a frequency spectrum, determined from the transmitted coherent wave, for the ratio of the scattering mean free path l_{S} to effective wavelength λ for the sample with an EMB equilibrium volume fraction ϕ=0.21%. The horizontal axis is plotted over the EMB resonance frequency range targeted by the experiments. For clarity, error bars (determined from uncertainties in the measured sound level and doped gel thickness) are shown for every 5th data point. The lower dashed line is a reference to l_{S}/λ=1. The shaded region highlights the frequency range over which l_{S}/λ≤1. The upper dashed line is an independent scattering approximation (ISA) prediction based upon Eq. 20.

FIG. 29 shows predicted EMB on-resonance effective diameter D_{eff} (open triangles) for a single, isolated EMB and the corresponding equilibrium diameter D_{O} (solid squares) versus frequency f.

FIG. 30 shows predicted EMB on-resonance effective diameter D_{eff} (open circles) versus frequency f for a single, isolated EMB along with a fit to a power model, which highlights the inverse relationship between D_{eff} and f.

FIG. 31 shows predicted EMB effective volume fraction ϕ_{eff} versus frequency f for an EMB equilibrium volume fraction ϕ=0.21%. The left shaded region highlights the range of f over which the independent scattering approximation (ISA) is qualitatively valid, which is determined from the fit shown in FIG. 28. The right shaded region highlights the frequency range where l_{S}/λ<1.

FIG. 32 shows reflected sound level (SL) versus frequency f for an undoped 4 mm-thick Uralite sample (open triangles) and for four samples with EMB equilibrium volume fractions ϕ=0.81% (lower solid triangles), ϕ=1.58% (solid circles), ϕ=1.95% (open squares), and ρ=2.55% (upper solid triangles). Here, the Uralite polymer thickness is the same thickness as the undoped Uralite pocket into which the doped gel is poured for the in-water measurements.

FIG. 33 shows the impulse wavepacket for the late-time incoherent wave analysis (i.e., for observing diffusive and localization effects). Pressure P versus time t for the sample with EMB equilibrium volume fraction ϕ=2.55% recorded during a transmission measurement and for different speckles. The incident wavepacket is based on a Gaussian first derivative, which provides a narrow impulse. The coherent wave is observable for 266 μs<t<272 μs, and is followed by the incoherent field. The incoherent field data shown here was used to obtain the data shown in FIG. 38 and FIG. 40 for ϕ=2.55%, and similar data sets were collected for the ϕ=1.58% and 1.95% samples to obtain the data shown in FIGS. 34-37 and for the ϕ=0.21% sample to obtain the data shown in FIG. 39. Inset: sound level SL frequency spectrum for the Gaussian first derivative wavepacket obtained during the water reference (no sample) measurement.

FIGS. 34-38 show incoherent wave analysis across the two asymptotic regimes: fluid-like (including diffusive states) and quasi-gaseous (f>f_{C}*; in FIG. 36-38 the 750-800 kHz frequency range corresponds to the quasi-gaseous phase). The normalized transmitted intensity peak envelope I/I_{O} (on a semi-logarithmic plot) is plotted versus time t for the incoherent energy and for the three doped samples for which data is presented in FIGS. 9-14: ϕ=1.58% in FIGS. 34-36, ϕ=1.95% in FIG. 37, and ϕ=2.55% in FIG. 38. Incoherent wave data is digitally filtered to target those frequency ranges shown in each figure part based upon the l_{S}/λ data shown in FIGS. 12-14. I/I_{O} is found from averaging over 11 different speckle measurements. Normalization is done so the input pulse peak is unity, and then so that in each figure part the maximum occurs at I/I_{O}=1. The time ranges are shifted from the experiment time so the maximum in I/I_{O} occurs shortly after t=0 μs. The straight line in FIG. 34 is a linear fit (diffusion) with the characteristic diffusion time z_{D} μserving as a free fitting parameter. Dashed lines in FIG. 35-37 are fits to the localization self-consistent theory (SCT) with D_{B}, ξ, and τₐ (bare diffusion coefficient, localization length, and characteristic absorption time, respectively) serving as free fitting parameters.

FIGS. 39-40 show wave localization effects (and SCT analysis) in EMB-doped gel for when l_{S}/λ<1. Normalized transmitted intensity peak envelope I/I_{O} (on a semi-logarithmic plot) plotted versus time t for the incoherent energy and for the two doped samples that represent the full range of ϕ over which the behavior of f_{C}* versus ϕ is studied (FIGS. 20-23). Incoherent wave data is digitally filtered to target those frequency ranges shown in each figure part where l_{S}/λ<1. I/I_{O} is found from averaging over 11 different speckle measurements. Normalization is done so the input pulse peak is unity. Data shown in FIG. 39 is the same data set shown in FIG. 38. The time ranges are shifted from the experiment time so the maximum in I/I_{O} occurs shortly after t=0 μs. Solid lines are fits to the self-consistent theory (SCT) of localization with D_{B}, ξ, and τₐ (bare diffusion coefficient, localization length, and characteristic absorption time, respectively) serving as free fitting parameters, and the resultant values from the SCT fits are shown in red. Dashed lines correspond to setting zₐ=10 ps in the SCT fit while keeping all other parameters fixed at the values specified.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a method for inducing a discontinuous binary acoustic phase transition in a resonant impurity-doped soft elastic material (e.g., gels and polymers) between fluid-like and gaseous-like phases at very low impurity equilibrium volume fractions (near 1%), which is frequency-driven, mediated by a range of frequency and impurity volume fraction over which l/λ<1 and wave localization effects, and leads to abrupt changes in acoustic properties including phase velocity, bulk modulus, and potential energy density. Here, the term soft refers to the inequality G<<B where G and B are the material's shear and bulk moduli, respectively. The technique promotes a material compatible, reproducible, and scalable fabrication process that generates well-tailored spherical gas cavities within a soft material with a finely controlled size and resonance frequency distribution that are impermeable to liquids. The technique is independent of the soft material's elastic moduli and the specific elastic parameters of the dopants, and is applicable across the full frequency spectrum. A few specific examples of applications afforded by the invention include: 1. Wearable sensors, micromachines, medical devices, and metamaterials made from soft materials wherein the soft material can have abrupt and switchable acoustic properties, 2. Materials with switchable time-dependent transmission and reflection coefficients governed by the physics of wave localization and resonant impurity-mediated wave delocalization for a vibration-free environment across a broad frequency band, and 3. Materials with switchable energy-absorbing properties governed by the physics of wave localization and resonant impurity-mediated wave delocalization.

Potential advantages and features include the observation of broadband and discontinuous phase change behavior in a soft material with very low impurity concentrations (near 1% EMB equilibrium volume fraction), the observation of an unanticipated wave delocalization mechanism that results in the discontinuous phase change behavior, a new binary phase diagram that is frequency driven and has non-intuitive transition kinetics (i.e., the binary phase transition between fluid-like and gaseous-like behavior is mediated by a phase in which waves are localized), the potential to further realize increased broadband behavior (in excess of 750 kHz) by sweeping the excitation frequency through the full range of EMB resonance frequencies, the potential to tune such binary phase transitions from the nanoscale (via the EMB properties), and the ability to tune such binary phase transitions with air volume fraction within a material.

There are currently no known alternative methods promoting: 1) the observation of a discontinuous phase transition in an impurity-doped soft material (polymers and gels) that is frequency-driven, mediated by a localized phase, and leads to abrupt changes in properties like phase velocity, bulk modulus, and potential energy density, 2) a tunable disorder strength via a change in frequency leading to such a binary phase transition, 3) the observed broadband behavior for the binary phase transition, 4) the observation of such broadband binary phase change behavior via resonant scattering of the impurities, 5) the ability to induce such a broadband binary phase transition with such low dopant volume fractions (˜1% impurity equilibrium volume fraction), 6) the tunability of the binary phase transition within bulk acoustic materials from the nanoscale, 7) the tunability of the binary phase transition with both excitation frequency and air volume fraction, and 8) the tunability of a material's transmission and reflection coefficients, in addition to energy absorption properties, by way of such a binary phase transition.

Here is discussed the wave propagation phenomenology of the discontinuous ultrasonic transition in encapsulated microbubble (EMB)-doped gel as a function of EMB equilibrium volume fraction ϕ over a large range of excitation frequency. It is shown that within the strong scattering limit (l/λ<1, where l and λ are the mean free path and effective wavelength, respectively), the behavior of the frequency-dependent change in phase angle Δθ switches abruptly from random-like to smooth at the critical excitation frequency, and the Δθ versus frequency slope changes by a factor as high as 5.6 also at the critical frequency, which signals a clear change in system behavior. Across samples, and at the critical frequency, the longitudinal phase velocity changes discontinuously to v̅_̅{̅L̅}̅=456 m/s with a standard deviation σ_{V}_{_{L}}=103 m/s, which is intermediate between the gel and the EMB gas sound speeds, and it was found that v_{L} remains fixed with increasing ϕ for frequencies above the critical frequency. The observed ϕ-independent phase velocity is in stark contrast to the conventional ϕ dependence that occurs in the system for frequencies below the critical frequency, as well as in other systems with non-resonant air and hard sphere colloid suspensions, and indicates an abrupt change in the acoustic propagation mode (the mode changes from waves/excitations in the fluid being scattered by resonating EMBs to excitations of the EMBs being coupled to one another by the fluid). Moreover, in the low-ϕ limit, the critical frequency follows a power law f*_{C} ∝<ϕ^{b} with b=2.715±0.002, which is unlike the linear ϕ dependence for the frequency at which l/λ=1 (which occurs at a lower frequency and is governed by the total amount of gas within the sample). The results cannot be explained by multiple scattering theory, viscous effects, mode decoupling, or a critical density of states, and it is therefore hypothesized that the discontinuous transition from fluid-like to gaseous-like behavior depends upon the microbubble on-resonance effective volume fraction, and the results are discussed within the context of percolation theory. Lastly, the timescale associated with the discontinuous behavior observed here is at least a factor 103 smaller than the timescale associated with light-induced discontinuous volume transitions observed in gels (˜5 ms) [20], which is the current state-of-the-art in terms of discontinuous changes in such materials.

The composition comprises a soft material and a plurality of encapsulated microbubbles within the soft material. A soft material is defined as having a bulk modulus larger than its shear modulus. The ratio of wherein the bulk modulus to the shear modulus may be at least 10, 20, 50, or 100. Suitable soft materials include suspending gels and hydrogels, such as those derived from polyacrylic acid. The acid groups may be neutralized.

The soft material may have negligible dissipation in the frequency range of interest, may be impedance matched to the surrounding environment (such as water), and may behave like an acoustic fluid. These properties may support the presence of the discontinuous acoustic property. The soft material may be placed into a box made out of a soft polymer, such as Uralite 3140 polyurethane. The polymer box thickness may be less than the minimum gel dimension. For example, the box may have a thickness of 4 mm to contain a 10 mm gel. The polymer box may also have negligible dissipation in the frequency range of interest, and may be impedance matched to the surrounding environment (such as water).

The EMBs may comprise, for example, a polyacrylonitrile shell and a gas within the shell. Example gases include isobutane and isopentane. The shell thickness may be about 100 nm. The microbubbles may range from 1 to 150 μm in diameter, including any subrange therein such as 10-140 μm. The average diameter may be 60-140 μm or smaller ranges such as 60-95 μm. The EMB diameter distribution may be from D(0.4) to D(0.6), including D(0.5).

The composition may include an EMB equilibrium volume fraction of, for example from 0.8% to 10%. When certain fractions are used, the composition exhibits a discontinuous change in an acoustic property relative to an applied frequency. This can be verified be methods described herein and otherwise known in the art. For example, the acoustic property may phase angle or longitudinal phase velocity.

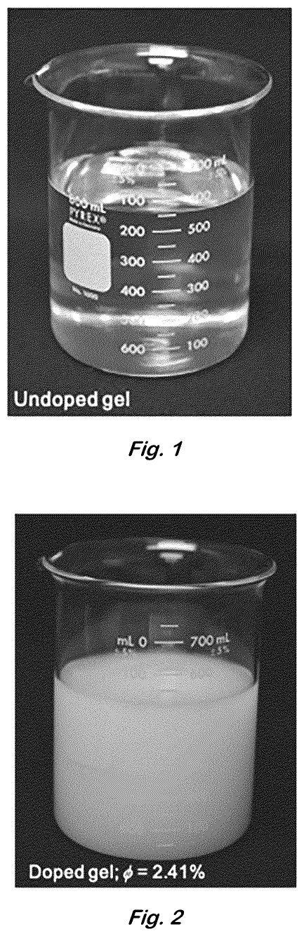

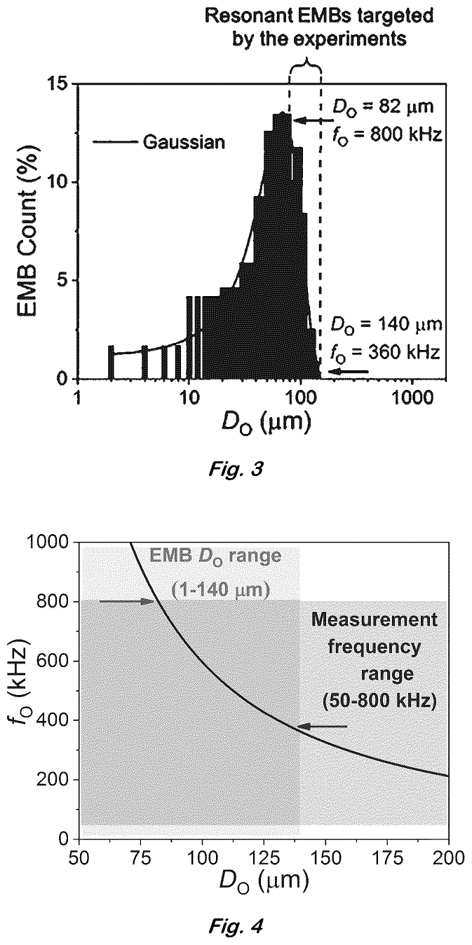

Ultrasound transmission and reflection measurements were performed on a suspending gel (an acoustic fluid) doped with resonant EMBs. The gel (Carbopol ETD 2050) was obtained from the LubrizOl Corporation. The expanded EMBs (043 DET 80 d20) were obtained from Expancel. Each sample was made using EMBs drawn from the same batch, and optical images showing representative undoped and doped gels, as well as the optical contrast change that occurs with EMB doping, are presented in FIGS. 1 and 2. The measured EMB size distribution is well-fitted by a Gaussian, which is shown in FIG. 3. The experiments target the largest EMB diameters within the distribution, and there is a large overlap between the experiment's frequency f range (50-800 kHz) and the EMB resonance frequency f_{O} range targeted by the experiments (360-800 kHz, see also FIG. 4); for 50 kHz<f<360 kHz, there are no resonating EMBs and so this frequency range serves as an additional reference to the behavior observed when the EMBs are resonating. Moreover, for f>360 kHz the number of resonating EMBs at each frequency (i.e., the density of active oscillators ρ_{active}) increases up to f=800 kHz; thus, a key advantage of this system is the in-situ tunability of the disorder strength, which is controlled by varying the frequency over the broad EMB size (i.e., resonance frequency) distribution because only resonating EMBs contribute to the scattering. Moreover, the EMB size polydispersity index can be estimated from σ/D̅, where σ and D̅ are the standard deviation and EMB average diameter obtained from the FIG. 3 Gaussian fit. Including all EMBs within the distribution yields a polydispersity index of ˜37%. However, at a particular frequency only a fraction of the EMBs within the distribution are resonating, and for an EMB with an outer equilibrium diameter D_{O}=90 μm, and based upon the full-width-at-half-maximum of the normalized scattering cross section versus frequency (see FIG. 5) and the FIG. 3 Gaussian fit, the on-resonance polydispersity index is estimated to be ˜8%.

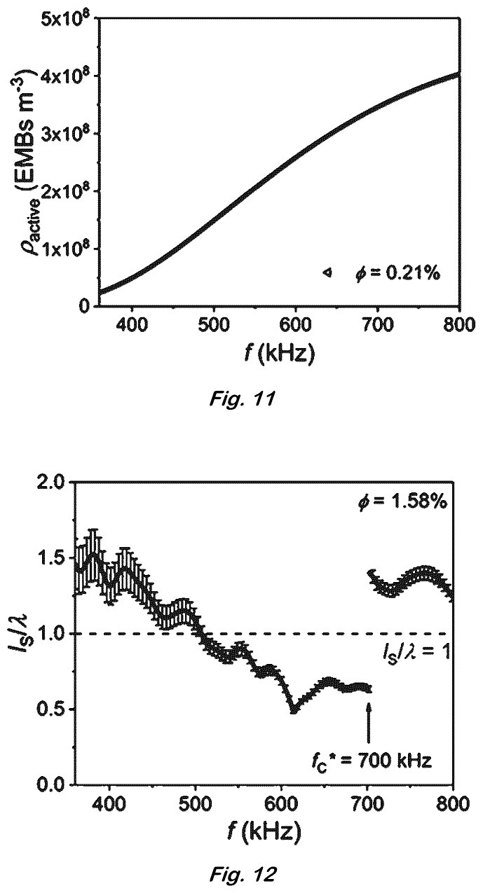

The EMB resonance frequency within the gel is shifted from the Minnaert formula for a gas bubble in water due to the gel and EMB shell elastic properties; for example, an EMB with D_{O}=90 μm (corresponding to f_{O}=695 kHz in the gel) has f_{O} a factor of 10.7 higher than a bubble in water with the same diameter. On resonance the single EMB effective volume V_{eff} can be much larger than the equilibrium volume, and on resonance the EMB effective scattering cross section within the gel σe_{ff} is several orders of magnitude larger than the equilibrium geometrical cross section σ, and at each frequency scattering is dominated by resonating EMBs (for example, for D_{O}=90 μm σe_{ff}=237σ). In this system EMB damping is dominated by acoustic radiation damping within the frequency range of interest, which is unlike damping in such systems as liquid foams where there exists a nontrivial frequency-dependent absorption due to viscous and thermal effects [18, 21]. See Note 1 below for information on EMB resonance frequency, scattering cross section, and damping. See Note 2 below for information on EMB density of states and the density of active oscillators (see also FIG. 11).

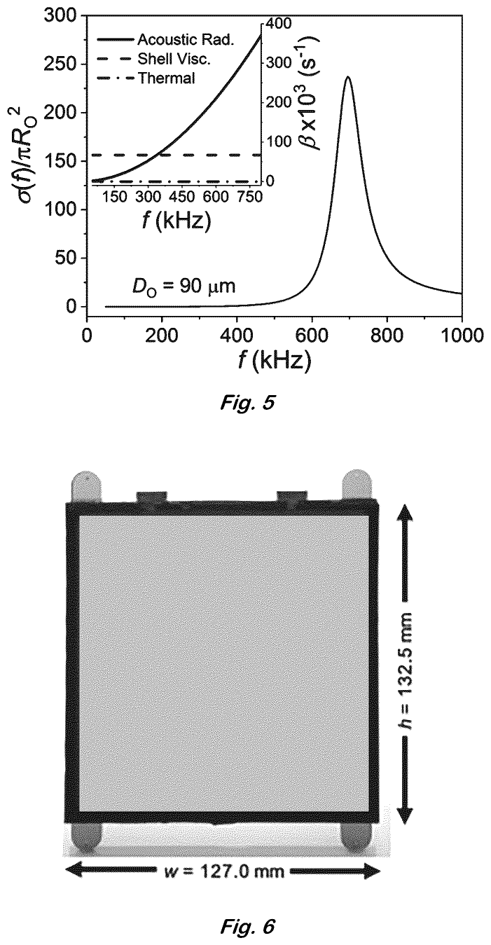

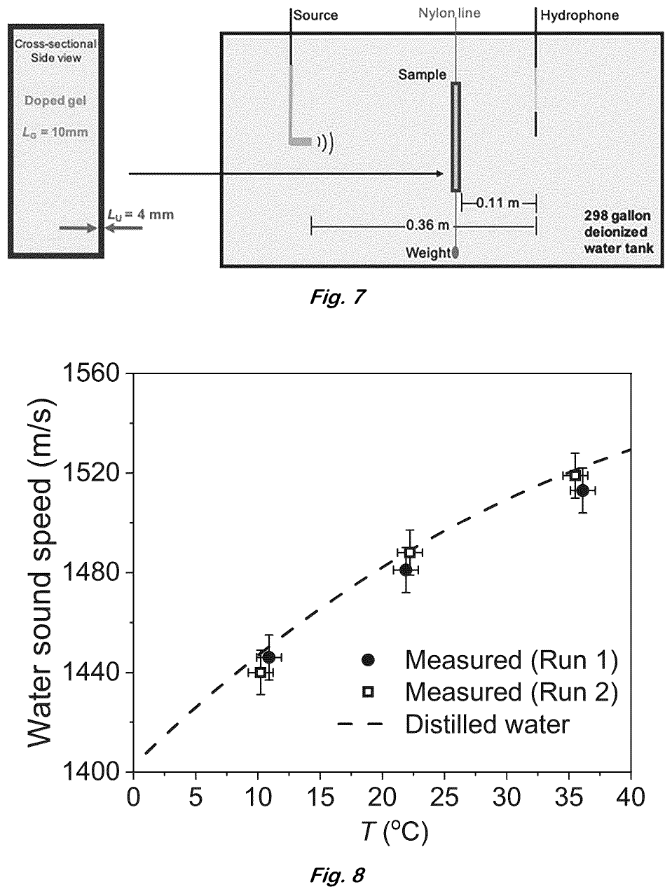

The doped gel was encased in a soft, low-loss, undoped polymer shell made from Uralite 3140 (FIGS. 6 and 7); Uralite 3140 is acoustically transparent in water, has negligible attenuation and reflection in the frequency range of interest, and acts as a structural support for the gel during the in-water measurements. The Uralite 3140 parts A and B were acquired from Ellsworth Adhesives. The doped gel thickness L_{G}=10 mm, and the Uralite shell into which the gel is poured has wall thickness L_{U}=4 mm. Additional sample and fabrication details can be found in Ref. 17.

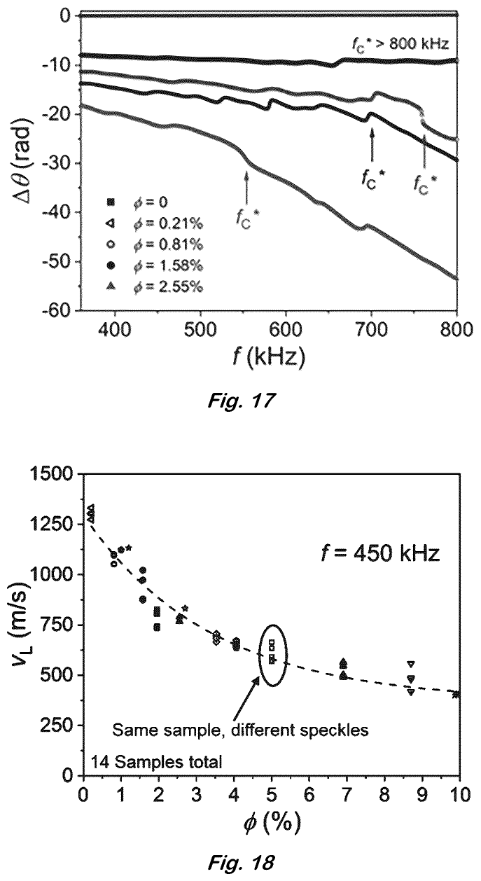

The experiments were carried out in water, at normal incidence, within the temperature T=297-299 K range, and utilized a 0.5 MHz piston-faced immersion transducer and a Reson TC 4035 hydrophone from Teledyne Marine. The in-water experimental setup used for the transmission measurements is shown in FIG. 7. The experiments used a Krohn-Hite 5920 arbitrary waveform generator, and the waveform was filtered with an Ithaco 4302 dual 24 dB/octave filter and then amplified using an E&I 240L RF power amplifier prior to the waveform reaching the source transducer. The hydrophone signal was amplified using an Ithaco 1201 low-noise preamplifier before being digitized for data collection and processing (at a 2 MHz sampling frequency). For each data set, one thousand measurements were collected and averaged, and then a subtraction was used to eliminate any y-axis offset. A water reference was measured immediately prior to measuring each sample so both the reference and sample data sets were collected under identical conditions. This experimental setup has been used to measure the water sound speed temperature dependence, which is in agreement with standard published results for distilled water (see FIG. 8), the properties of the undoped gel (see, for example, the Δθ frequency spectrum for ϕ=0 in FIG. 17), and the properties of soft materials doped with non-resonating EMBs to comparable ϕ values [2], and w discontinuous wave speed behavior has not been observed in any of these prior reference measurements.

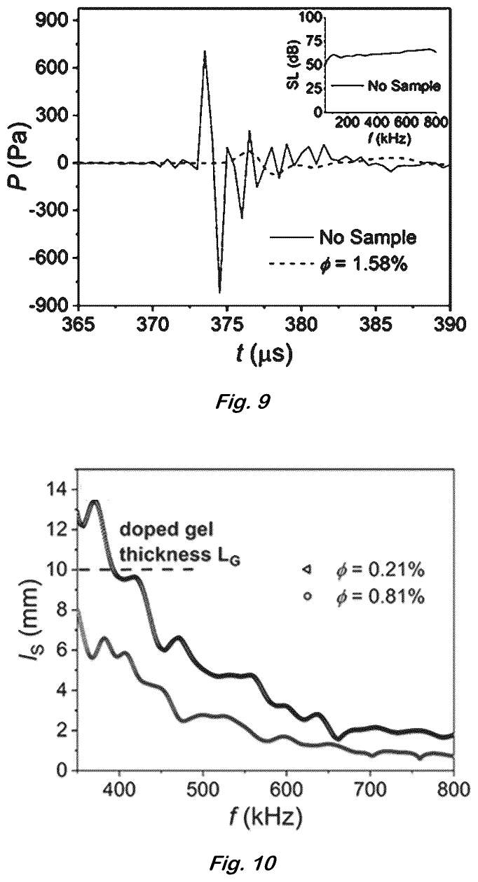

FIG. 9 shows pressure P versus time t for the wavepacket recorded during the water reference (no sample) measurement, and for the coherent part of the transmitted wave for ϕ=1.58%±0.05%; in this case, the maximum positive pressure decreases by a factor of 9.3 upon doping the gel with EMBs. Here, ϕ is determined through measurements of the undoped and doped gel densities using a graduated cylinder with a volume determined by a calibration measurement using water of known temperature and density, and by using an ideal mixture model for the doped gel density ρ=ϕ_{gel}ρ_{gel}+ϕ_{EMB}ρ_{EMB}; ϕ is also a measure of the total sample volume occupied by the EMBs in their equilibrium state and so each ϕ corresponds to a different sample. Also, shown in the FIG. 9 inset is the reference wavepacket's measured sound level (SL) frequency spectrum, which shows the incident wavepacket exhibits a relatively flat response from 50-800 kHz, which aligns with the hydrophone's usable frequency range (10 kHz-800 kHz). FIG. 10 shows the scattering mean free path l_{S} frequency spectra for the two samples with the lowest ϕ(0.21%±0.04% and 0.81%±0.04%) where is l_{S} determined from the normalized intensity I/I_{O}=e^{-(L}^{_{G}}^{/l}^{_{S}}⁾, l_{S}=(2α)⁻¹ where α is the attenuation coefficient, and I_{O} is determined from a water reference measurement [22]. In this system, monopole scattering dominates, and so the scattering and transport mean free paths are equal. FIG. 10 highlights how l_{S} decreases with increasing f above the minimum EMB f_{O}˜360 kHz to values considerably less than L_{G}=10 mm (the smallest sample dimension), and this continuous decrease is due to an increasing ρ_{active} with increasing f. As an example, FIG. 11 shows ρ_{active} (determined through the measured EMB size distribution, EMB theory, and accounting for the finite σ(f) peak width) versus f for ϕ=0.21%, and highlights how the number of scatterers contributing to the scattering increases with increasing frequency over the experimental frequency range.

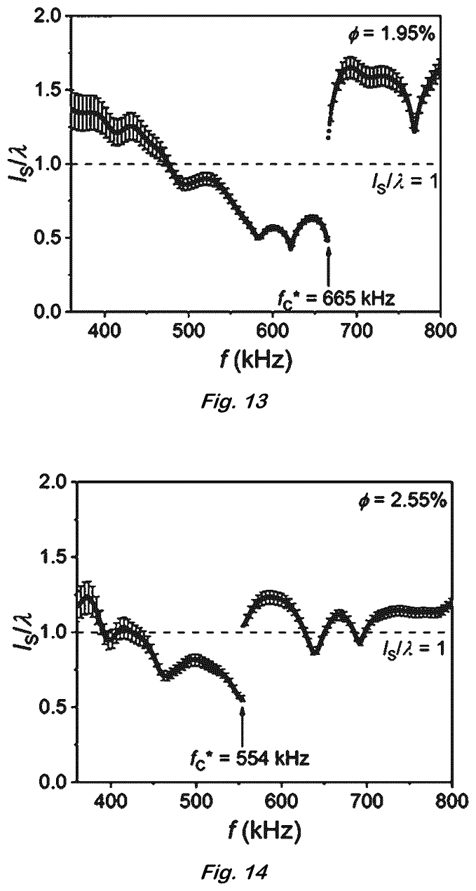

FIGS. 12-14 show the measured l_{S}/λ frequency spectra for varying ϕ:ϕ=1.58%, 1.95%±0.05%, and 2.55%±0.05%; note, l_{S} and λ are determined from the transmitted coherent wave after time-windowing the data, and v_{L} and λ are determined from the measured Δθ(Note 3 below for information on Δθ, v_{L}, λ, and l_{S}). Shown in FIGS. 12-14, l_{S}/λ decreases with increasing f due to the increasing disorder strength with increasing frequency. Further, it is observed in the strong scattering limit (l_{S}/λ<1) l_{S}/λ exhibits a discontinuous rise to values above unity, and this critical excitation frequency is labeled f_{C}*. It is found that f_{C}* shifts to lower frequency with increasing ϕ:f_{C}*=700 kHz, 665 kHz, and 554 kHz for ϕ=1.58%, 1.95%, and 2.55%, respectively. The discontinuous l_{S}/λ rise at f_{C}* occurs because v_{L} decreases at this frequency by a factor of about two, which agrees with prior results for the observed wave speed change at the critical frequency [17]. Additionally, at f_{C}*=665 kHz for ϕ=1.95%, α=933 Np/m was measured, which is a factor 62 higher than α=15 Np/m for the undoped sample (undoped gel in the Uralite-based shell), which exemplifies minimal attenuation due to the undoped materials in the absence of the EMBs.

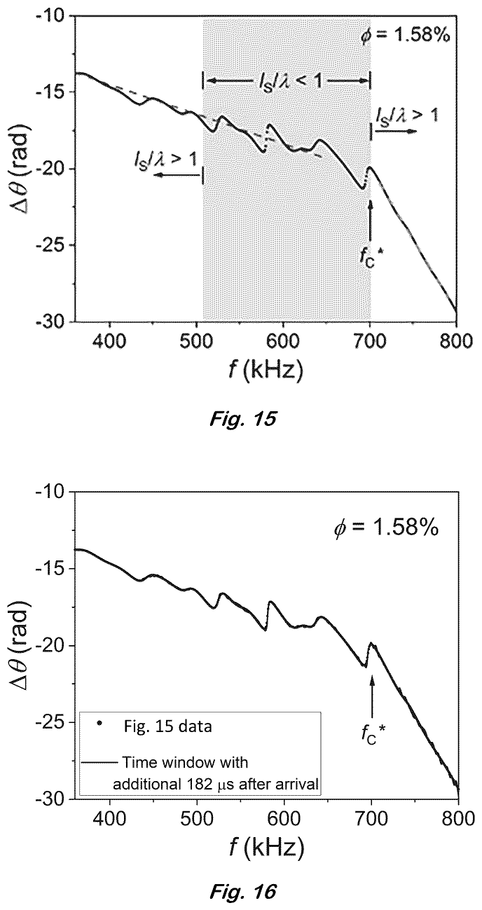

FIG. 15 shows the Δθ frequency spectrum for ϕ=1.58% where Δθ is determined from the transfer function of the fast Fourier transforms for the sample and water reference data sets. As seen in FIG. 15, random-like behavior in Δθ versus f is observed with increasing frequency, and is most prominent within the frequency range where the condition l_{S}/λ<1 is satisfied; such random-like behavior indicates a strongly scattering material. However, the random-like Δθ(f) behavior is not detected for f>f_{C}*=700 kHz. Also, f_{C}*=700 kHz is the frequency at which the Δθ versus f slope changes by a factor of 4.9 (compare the slopes of the dashed lines in FIG. 15), which indicates a change in material wave speed (for this factor of 4.9 change in slope, v_{L} is reduced from 874 m/s±4 m/s to 398 m/s±3 m/s). Thus, the absence of the random-like Δθ(f) behavior for f>700 kHz, along with the Δθ(f) change in slope at f_{C}*, indicates a clear change in the system's effective properties with broadband behavior on each side of the critical frequency. The discontinuous behavior is not the result of insufficient late-time data or signal processing. The Δθ versus f data shown in FIG. 15 was determined from the wavepackets shown in FIG. 9, and data is collected for an additional 950 μs following the wavepacket's arrival at the hydrophone (the water reference wavepacket, sculpted to have a flat SL across a specific frequency range, has a pulse width of ˜20 μs and pulse length 1,492 m/s×20 μs=30 mm). Also, the data is time-windowed to avoid tank reflections, and the inclusion within the time-windowed data of an additional 182 μs after the wavepacket's arrival (up to the first tank reflection) was confirmed to not change the results (see FIG. 16). Moreover, FIG. 17 shows Δθ versus f for multiple samples (including for ϕ=0 where no discontinuous behavior was observed), and these data sets highlight how f_{C}* shifts to lower frequency with increasing ϕ, which suggests a critical parameter for the observed transition. For the FIG. 17 data, the Δθ versus f slope changes at f_{C}* by a factor of 5.6, 4.9, and 2.8 for ϕ=0.81%, 1.58%, and 2.55%, respectively, between the different regimes.

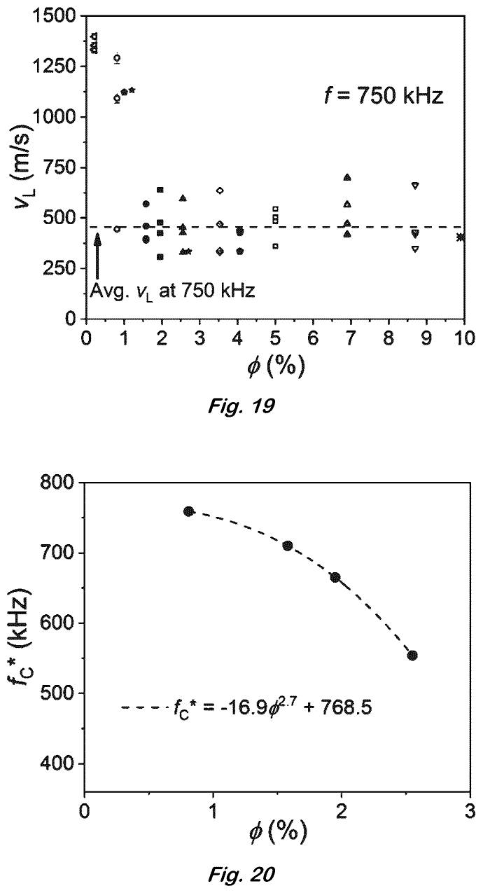

FIG. 18 shows a plot of v_{L} versus ϕ for f<f_{C}* (specifically, at 450 kHz), and FIG. 19 shows a plot of v_{L} versus ϕ for f>f_{C}* (specifically, at 750 kHz); note, in FIG. 19 there are a few exceptions at the lowest ϕ where the discontinuous transition was expected to occur at a frequency above the highest experimental frequency, however, all data points in FIG. 19 below 750 m/s correspond to the gaseous-like phase where f>f_{C}*. Moreover, for each ϕ value in FIGS. 18 and 19, v_{L} values measured are plotted across speckles to provide a measure of the speckle-dependent spread in v_{L}. For measuring within independent speckles, the sample was displaced within the plane perpendicular to the central axis from the source to the hydrophone, and displacements larger than the wavelength of sound in water at 500 kHz (λ˜3 mm) were used. The sample was displaced so the source-hydrophone central axis traced a circle counterclockwise about the sample center. Furthermore, the hydrophone sensor's aerial dimensions are smaller than the speckle coherence area (˜λ²), which ensures measurements within independent speckles. FIG. 18 shows for f<f_{C}* v_{L} can be fit with an exponential function for increasing ϕ. Contrarily, FIG. 19 shows for f>f_{C}*v_{L} is ϕ independent (despite the increased spread in v_{L} across speckles) and has an average value v̅_̅{̅L̅}̅=456 m/s with a standard deviation σ_{V}_{_{L}}=103 m/s.

The most notable feature within the FIGS. 18 and 19 data is that v_{L} is ϕ independent for f>f_{C}*, which is unlike the behavior observed here for f<f_{C}* where the strong dependence of v_{L} on ϕ is similar to that observed in soft materials where single and multiple scattering theories are applicable [2,3]. The ϕ-independent v_{L} is also unlike that observed in experiments measuring Mie scattering of monodisperse hard-sphere colloids [23] where different excitations (resonant and interfacial) have phase velocities that vary with ϕ. The f_{C}* transition being governed by viscous effects can be ruled out because the viscous penetration depth δ is always less than D_{O} where δ=(2η/ωμₗ)^{1/2} and η and ρₗ are the gel viscosity and density, respectively, and ω=2πf. That δ is always less than D_{O} across the frequency range of interest suggests δ is not an order parameter for the observed discontinuous behavior. Also, because δ is always less than D_{O} the Biot theory can be ruled out for long-wavelength sound propagation in a porous medium that considers mode decoupling and sound propagation through the inhomogeneous fluid between the scatterers when δ becomes less than the pore size [24,25]. Further, FIG. 19 shows the measured v_{L} for f>f_{C}* is not the increase one might expect to accompany wave propagation through the system's inter-scatterer medium (v_{L} approaching that of the undoped gel), but instead is fixed at a value that is intermediate between that of the gel (1,498 m/s for the undoped sample) and the EMB gas (˜200 m/s) [26]. The acoustic phase for f>f_{C}* is referred to as “quasi-gaseous” because the resultant wave speed is very different from the pure fluid-like gel. See Note 4 below for information on the viscous penetration depth and Biot theory.

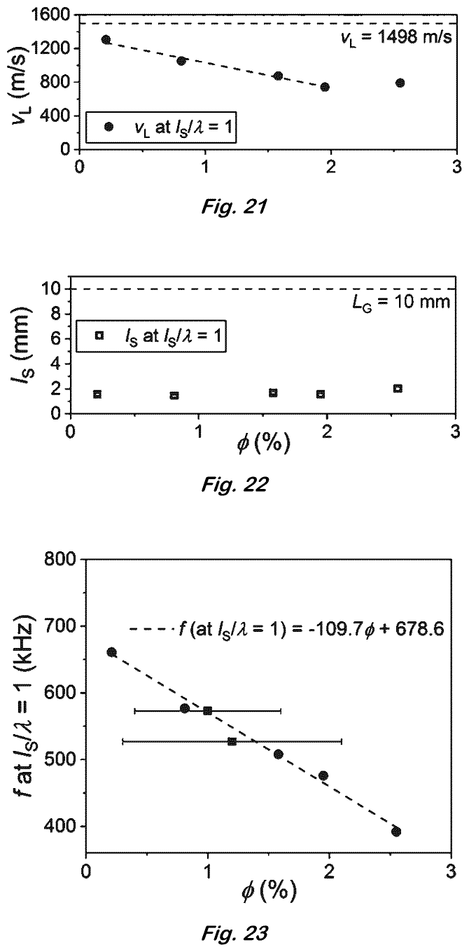

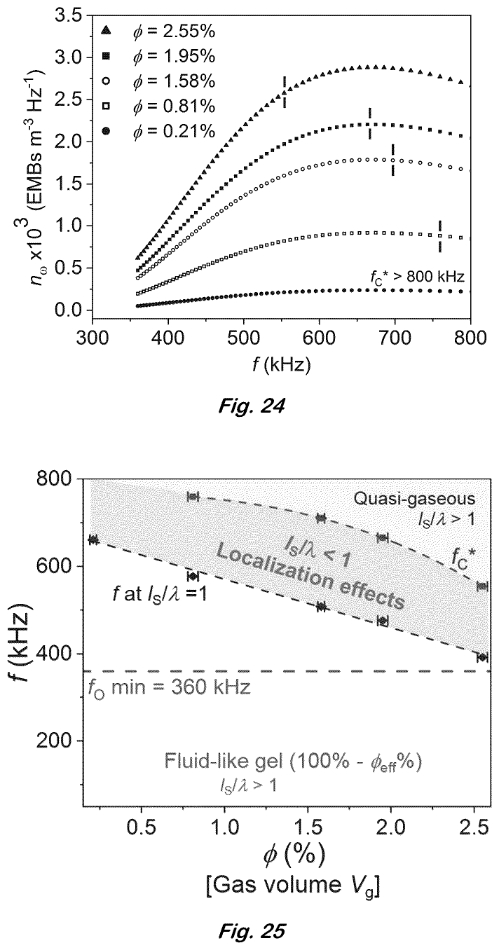

FIG. 20 shows f_{C}* versus ϕ follows a power law in the low-ϕ limit: f*_{C} ∝ϕ^{b} with b=2.715±0.002 determined from a least-squares fit. The observed power law behavior for f_{C}* on ϕ is unlike the linear ϕ dependence measured for the frequency at which l_{S}/λ=1 (which occurs for f<f_{C}*, and also shifts to lower frequency with increasing ϕ), which is shown in FIG. 23. Moreover, FIG. 21 shows v_{L} at l_{S}/λ=1 also varies linearly with ϕ (in the low-ϕ limit where the v_{L}(ϕ) exponential form shown in FIG. 18 can be approximated as linear), and FIG. 22 shows is at l_{S}/λ=1 is fairly constant across samples with an average value l̅_̅{̅S̅}̅=1.66 mm (σₗ_{_{S}}=0.23 mm). Based upon v_{L}=f_{λ}=l_{S}, the FIGS. 21-23 data suggests the linear behavior for f(ϕ) at l_{S}/λ=1 μshown in FIG. 23 is primarily the result of a linearly changing v_{L} with varying ϕ (a measure of the total sample volume occupied by the EMBs); this is qualitatively similar to the smoothly-varying changes in v_{L} that occur in systems even with non-resonant gas-filled impurities [2, 3]. Additionally, the FIG. 23f versus ϕ slope (−109.7 kHz) is near (a factor 1.6 lower than) the slope of v_{L} vs. ϕ when divided by l_{S} (−180.9 kHz), which suggests a common origin for the linear behaviors shown in FIGS. 21 and 23; an abrupt change in v_{L} at l_{S}/λ=1 was not observed. Contrarily, the f_{C}* versus ϕ power law behavior suggests a different origin from a simple dependence on the overall EMB equilibrium volume fraction. Moreover, the f_{C}* transition being governed by a critical density of states n_{ω}(EMBs m⁻³ Hz⁻¹) can be ruled out because n_{ω} varies by 66% at f_{C}* between ϕ=0.81% and ϕ=2.55% (see FIG. 24).

FIGS. 18 and 19 show the dependence of v_{L} on ϕ at two frequencies to exemplify the different sound speed behaviors on opposite sides of f_{C}*. However, in these experiments the system's acoustic phase diagram was mapped, which is realized by measuring the dependence of the frequencies f(at l_{S}/λ=1) and f_{C}* on ϕ at constant temperature, external pressure, and sample volume. The FIG. 25 diagram shows f(at l_{S}/λ=1) and f_{C}* versus ϕ, and since ϕ is the EMB equilibrium volume fraction it is also a measure of the total gaseous volume V_{g} if one ignores the approximately 100 nm-thick EMB shell; note, plotting the diagram with ϕ as the independent variable decouples the x-axis from the system's frequency dependence as ϕ is simply a measure of the EMB fractional volume (which is frequency independent). Also shown on the FIG. 25 diagram are the same fittings shown in FIGS. 20 and 23 (upper and middle dashed lines, respectively). Thus, FIG. 25 shows a binary acoustic phase diagram, which consists of the fluid-like gel and quasi-gaseous phases, which are mediated by a range of f and ϕ over which l_{S}/λ<1; thus, the region of the phase diagram over which l_{S}/λ<1 is satisfied can be thought of as a frequency-dependent transition region between the fluid-like and quasi-gaseous regimes. Moreover, the FIGS. 18 and 19 data can be understood as slices of the diagram at constant frequency with the sound speed ϕ dependence indicated by the shading. Lastly, the observed discontinuous behavior occurs along the upper dashed line connecting the FIG. 25 f_{C}* data points.

It is known that a first-order, reversible phase transition can be induced within a gel due to swelling and shrinking of the gel's polymer network [20, 27-31]. The discontinuous volume change can be induced by varying, for example, the gel's temperature, solvent composition, or pH level, and can also be induced with exposure to visible light; in some cases, volume changes with swelling ratios near 10³ have been observed [27,28]. However, the volume expansion is slow and requires timescales on the order of hours to days for the system to reach equilibrium and for the transition to become discontinuous [27, 29]. It is possible to reduce the timescale to several milliseconds with exposure to visible light [20]; however, such physics would be restricted to the light's penetration depth within the gel's host medium and would require a constant light source to maintain an equilibrium temperature. The FIG. 25 data shows the lowest f_{C}* observed for the discontinuous transition is 554 kHz, which corresponds to a period T=1/f=1.8 μs. Thus, the timescale associated with the discontinuous behavior observed here is at least a factor 10³ μsmaller than the timescale associated with light-induced discontinuous volume transitions observed in gels (˜5 ms) [20].

It is reasonable to associate v_{L} with the materials adiabatic bulk modulus B through v_{L}=(B/μ_{M})^{1/2} where μ_{M} is the constant equilibrium material density [32], and so a discontinuity in v_{L} at f_{C}* corresponds to a discontinuity in B and therefore a measured discontinuous change in material elastic properties. Further, the instantaneous potential energy density εₚ is related to B through

$${ℰ}_{p} = \frac{1}{2} \frac{{P}^{2}}{{ρ}_{{M}^{v} L}^{2}} \approx \frac{1}{2} {Bs}^{2}$$

where s is the condensation [32] and so the system's total internal energy density is also discontinuous at f_{C}*. That B is intermediate between that of the fluid and EMB gas suggests the discontinuous changes in B and EP are governed by an effective critical gas (i.e., EMB) volume fraction the frequency excitation of which couples the resonance behavior of the EBMs to one another by the surrounding fluid; in a sense, a dual system with interchanging roles of the two media.

In this system, the frequency-dependent EMB on-resonance effective volume fraction ϕ_{eff}(f)=(λ/6)[n_{ω}* Δ_{ω}>](D_{eff}(f))³ can be significant where Δω and the EMB effective diameter D_{eff} are determined by EMB theory and the measured EMB size distribution. In Note 5 below, it is shown that for the range of f and ϕ over which the independent scattering approximation is valid (f<600 kHz and the lowest ϕ=0.21%)ϕ_{eff} can vary between 11.5% and 27.5%, which explains how such effects are observable despite the low EMB equilibrium volume fraction of a few percent. It is worth noting such high ϕ_{eff} are near the predicted three-dimensional percolation threshold volume fraction, which for most real mixtures falls within the 0.25-0.29 range [33]. It is therefore hypothesized that the observed discontinuous ultrasonic transition from fluid-like to gaseous-like behavior depends upon the microbubble on-resonance effective volume fraction, which reaches a percolation threshold when the EMB resonances become coupled by the surrounding fluid resulting in a discontinuous change in measured material properties.

Based upon the measured EMB size distribution (FIG. 3), the smallest D_{O} is within the 1-10 μm range. An EMB with D_{O}=1 μm has a predicted f_{O}=660 MHz, and so for f>660 MHz there are no resonating EMBs in this system. Thus, one anticipates the EMB size distribution to restrict the range of frequencies over which the quasi-gaseous phase will be observed, since for f>660 MHz the lack of resonating EMBs would imply a transition back to a fluid-like phase. That the experiment's maximum frequency (800 kHz) is near the frequency associated with the maximum in the EMB size distribution suggests the system will return to a fluid-like phase within increasing f with a band of frequencies over which l_{S}/λ<1 is satisfied (mirroring the behavior observed between 50 kHz and 800 kHz). Therefore, the broadband behavior observed here on either side of f_{C}* could in principle be extended further in frequency.

As indicated on the FIG. 25 diagram, the range of f and ϕ for which l_{S}/λ<1 is also the range where effects of impurity-induced wave localization have been observed [17,34], and in Note 6 below provides a discussion and additional evidence for localization effects occurring within these samples for the range of f and ϕ specified. Note 6 provides evidence for wave diffusion for f<f(at l_{S}/λ=1), a slowing of diffusion for f (at l_{S}/λ=1)<f<f_{C}* consistent with the localization self-consistent theory, and a loss of the incoherent signal for f>f_{C}* (indicating the absence of diffusive and localized states within this frequency band).

Lastly, it is known that the bubble response can be pressure dependent, and that linear and semi-linear theories are not valid in the regime of large amplitude bubble oscillations and in the presence of strong inter-bubble interactions [35-38]. This theoretical analysis has been restricted to linear models for bubble dynamics due to the low driving pressures used (FIG. 9 shows a maximum pressure less than 1 kPa). First, from the compressive force on a resonant bubble [39] and the EMB shell shear modulus G_{S}˜1 GPa determined from prior works [2] it is estimated that the ratio of the EMB outward displacement ζ to equilibrium radius R_{O} to be of order 10⁻⁷ for a 1 kPa driving pressure. It is also estimated that ζ/R_{O} is more than 20 times smaller than that for lipid-coated bubbles at the same driving pressure; lipid-coated bubbles have been used to demonstrate nonlinear effects within the 12.5 kPa-100 kPa driving pressure range where ζ/R_{O} can be of order 10⁻⁴ to 10⁻³, respectively (these ζ/R_{O} values for the lipid-coated bubbles were obtained using the same analysis and the shell shear modulus G_{S}=45 MPa provided in Ref. 36). Thus, a nonlinear bubble response is not expected at the low driving pressure used in these experiments, which follows other experiments regarding sound transmission through gels doped with bubbles of comparable diameter and volume fraction [40]. Second, efforts have been made to develop nonlinear models that account for bubble-bubble interactions [36,38], and these models predict sudden pressure induced changes in acoustic properties in the high-pressure limit that can shift to lower frequency with changing pressure and void fraction. However, the pressures considered in Ref's 36 and 38 are at least a factor of 10 higher than the maximum pressure used in these experiments, and the sudden changes have been predicted to occur primarily for pressures higher than 100 kPa. For these reasons, this analysis is restricted to linear models.

A discontinuous ultrasonic transition between fluid-like and gaseous-like regimes as a function of encapsulated microbubble volume fraction was demonstrated. The results show the transition always occurs in the strong-scattering limit (l/λ<1), the random-like behavior of the change in phase angle versus frequency becomes smooth at the transition's critical frequency, that at the critical frequency the effective phase velocity changes discontinuously to a value that is constant with increasing microbubble volume fraction, and the measured critical frequency shows a nontrivial power law dependence on microbubble volume fraction. The results cannot be explained by multiple scattering theory, viscous effects, mode decoupling, or a critical density of states, and a percolation transition governed by the encapsulated microbubbles on-resonance effective volume fraction for the observed discontinuous behavior is hypothesized. The results shed light on the transition's physics, suggest a broad range of tunable properties for soft materials with potential application in ultrasonic actuators and switches, and afford a system for studying resonant microbubble interactions at high effective volume fractions and possibly a percolation transition in three dimensions.

### Note 1—EMB Resonance Frequency, Scattering Cross Section, and Damping

The encapsulated microbubble (EMB) linear harmonic oscillation is obtained from solutions of a Rayleigh-Plesset-like differential equation [42], which considers damping due to acoustic radiation and the EMB shell viscosity. The EMB resonance frequency f_{O} and angular frequency ω_{O}=2πf_{O} prediction takes into account both the EMB shell and suspending gel densities (ρ_{S}=1184 kg/m³ for the EMB shell, and the gel density was determined separately for each sample prior to adding the dopants so that the EMB volume fraction ϕ could be obtained; for example, for ϕ=0.81% the starting gel density was determined to be ρₗ=995.0 kg/m³±0.2 kg/m³), the shell inner and outer radii (a shell thickness ε=100 nm is assumed based upon prior scanning electron microscopy measurements [43]), the gel hydrostatic pressure (taken to be P=101.325 kPa), the enclosed gas polytropic index (γ˜1.1), and the shell shear modulus (G_{S}˜1.43 GPa) that was studied in prior work [44]. The resonance angular frequency can be expressed in terms of the EMB equilibrium diameter D_{O} as

$$\frac{1}{{ω}_{O}^{2}} = \frac{\begin{matrix}{D}_{O}^{2} [ ( {D}_{O}^{3} {ρ}_{l} ) / 4 + ( {D}_{O}^{2} ε ( {ρ}_{S} - 3 {ρ}_{l} ) ) / 2 + \\ {D}_{O} {ε}^{2} ( 3 {ρ}_{l} - 2 {ρ}_{S} ) + 2 {ε}^{3} ( {ρ}_{S} - {ρ}_{l} ) ]\end{matrix}}{{D}_{O}^{3} 3 γ P + {D}_{O}^{2} 24 {G}_{S} ε - {D}_{O} 48 {G}_{S} {ε}^{2} + 32 {G}_{S} {ε}^{3}} \qquad ( Eq . 1 )$$

Keeping terms to first order in ε results in

$$\frac{1}{{ω}_{O}^{2}} = \frac{{D}_{O}^{2} [ ( {D}_{O}^{3} {ρ}_{l} ) / 4 + ( {D}_{O}^{2} ε ( {ρ}_{S} - 3 {ρ}_{l} ) ) / 2 ]}{{D}_{O}^{3} 3 γ P + {D}_{O}^{2} 24 {G}_{S} ε} \qquad ( Eq . 2 )$$

Keeping terms to first order in ε is a good approximation to ω_{O}: in the numerator the ε term is over two orders of magnitude larger than the ε² term and over five orders of magnitude larger than the ε³ term, while in the denominator the ε term is over three orders of magnitude larger than the ε² term and over six orders of magnitude larger than the ε³ term.

In the limit that ε goes to zero, the Minnaert formula is recovered for a gas bubble [45]: for D_{O}=90 μm, the Minnaert formula predicts f_{O}=64,850 Hz, which is far below the experiment's frequency range and does not explain the sound transmission properties of the samples between 50-800 kHz. However, to first order in ε the resonance frequency can be written in terms of the EMB equilibrium radius R_{O} as

$${f}_{O} = \frac{1}{2 π} \sqrt{\frac{3 {R}_{O} γ P + 12 {G}_{S} ε}{{R}_{O}^{2} [ {R}_{O} {ρ}_{l} + ε ( {ρ}_{S} - 3 {ρ}_{l} ) ]}} \qquad ( Eq . 3 )$$

This expression yields f_{O}=695,055 Hz for D_{O}=90 μm, which is in agreement with the experimental results. Thus, to leading order in ε, the resonance frequency is shifted by the two new terms 12G_{S} ε and ε (ρ_{S}−3ρₗ) resulting in a modified Minnaert formula due to the suspending gel and EMB shell properties.

For a specified EMB diameter the ω-dependent scattering cross section σ(ω) is given by

$$σ ( ω ) = 4 π {R}_{10}^{2} ( \frac{{ρ}_{l}^{2}}{{ρ}_{S}^{2} {a}^{2}} ) ( \frac{{ω}^{4}}{{( {ω}^{2} - {ω}_{O}^{2} )}^{2} + {( 2 β ω )}^{2}} ) \qquad ( Eq . 4 )$$

where a=[1+((ρₗ−ρ_{S})/ρ_{S}) R₁₀/R₂₀], R₁₀ and R₂₀ are the inner and outer EMB equilibrium radii, respectively, and β is the total damping coefficient. Damping from acoustic radiation β_{AR} is determined by

$${β}_{AR} = \frac{{ρ}_{l}}{{ρ}_{S} a} {\frac{{ω}^{2} {R}_{10}}{2 {v}_{O}} [ 1 + \frac{{ρ}_{l}^{2}}{{ρ}_{S}^{2} {a}^{2}} \frac{{ω}^{2} {R}_{10}^{2}}{{v}_{O}^{2}} ]}^{- 1} \qquad ( Eq . 5 )$$

where v_{O} is take to be the measured (effective) phase velocity for each sample (i.e., for each value of ϕ).

FIG. 5 shows the predicted σ(f) for a single, isolated EMB with D_{O}=90 μm (normalized to the equilibrium scattering cross section), which takes into account acoustic radiation damping. On resonance, the effective scattering cross section is several orders of magnitude larger than the equilibrium scattering cross section. Further, the inset to FIG. 5 shows that acoustic radiation damping dominates the damping coefficient within the frequency range of interest, which is where the EMB resonance frequency range overlaps the experimental frequency range (primarily, 400-800 kHz). Damping from the EMB shell viscosity β_{SV} is determined by

$${β}_{SV} = \frac{2 {μ}_{S} ( {R}_{20}^{3} - {R}_{10}^{3} )}{a {ρ}_{S} {R}_{10}^{2} {R}_{20}^{3}} \qquad ( Eq . 6 )$$

where μs˜10 Pa*s is the estimated PAN shell shear viscosity [46]. The thermal damping coefficient for EMB oscillations [47] is determined from

$${β}_{TH} = \frac{9 {P}_{O} {κ ( 1 + {Δ}_{P} {R}_{10} / {R}_{20} )}^{- 1} [ {G}_{+} ( \sqrt{{Pe}_{g}} ) - 2 / {Pe}_{g} ]}{\begin{matrix}2 {ρ}_{S} {R}_{10}^{2} ( κ - 1 ) ω \{ {[ 3 {G}_{-} ( \sqrt{{Pe}_{g}} ) + 1 / ( κ - 1 ) ]}^{2} + \\ {9 [ {G}_{+} ( \sqrt{{Pe}_{g}} ) - 2 / {Pe}_{g} ]}^{2} \}\end{matrix}} \qquad ( Eq . 7 )$$

where Δ_{P}=(ρₗ−ρ_{S})/ρ_{S}, Pe_{g}=2ωρ_{g}c_{g}R₁₀²/k_{g} is the gas Peclet number (for isopentane ρ_{g}=616 kg/m³, c_{g}=1,660 J/kg*K, and k_{g}=0.11 W/m*K was used), and G± is given by

$${G}_{\pm } ( \sqrt{{Pe}_{g}} ) = \frac{1}{\sqrt{{Pe}_{g}}} [ \frac{sinh ( \sqrt{{Pe}_{g}} ) \pm sin ( \sqrt{{Pe}_{g}} )}{cosh ( \sqrt{{Pe}_{g}} ) - cos ( \sqrt{{Pe}_{g}} )} ] \qquad ( Eq . 8 )$$

Lastly, in computations of σ(ω), β_{AR}, and the angular frequency dependent mean free path l(ω) it is useful to know the value of D_{O} corresponding to each EMB ω_{O}. D_{O} is solved as a function of ω_{O} by solving the following cubic equation, which follows from the modified Minnaert formula keeping only terms to leading order in ε:

$${D}_{O}^{3} + 2 ε ( \frac{{ρ}_{s} - 3 {ρ}_{l}}{{ρ}_{l}} ) {D}_{O}^{2} - ( \frac{12 γ P}{{ρ}_{l} {ω}_{O}^{2}} ) {D}_{O} - \frac{96 {G}_{S} ε}{{ρ}_{l} {ω}_{O}^{2}} = 0 \qquad ( Eq . 9 )$$

### Note 2—the Density of States and the Density of Active Oscillators

The number of EMBs on resonance at the resonance frequency f_{O} can be expressed as

$${n}_{EMB} ( {f}_{O} ) = {n}_{{EMB}_{tot}} * ( distribution ( {f}_{O} ) ) \qquad ( Eq . 10 )$$

where n_{EMB}_{ₜₒₜ} is the total number of EMBs within a sample (i.e., for each value of EMB equilibrium volume fraction ϕ). Through knowledge of the relationship between D_{O} and f_{O} (Note 1) one can also write this expression as

$${n}_{EMB} ( {D}_{O} ) = {n}_{{EMB}_{tot}} * ( Gaussian distribution ( {D}_{O} ) ) \qquad ( Eq . 11 )$$

where “Gaussian distribution(D_{O})” is the solid line shown in FIG. 3 (thus, in computing the density of states n_{ω}, use the normalized Gaussian fit to the FIG. 3 data). To compute n_{EMB}(D_{O}) and therefore n_{EMB}(f) it is necessary to determine n_{EMB}_{ₜₒₜ} for each ϕ value. If all EMBs within a sample had the same diameter then the total EMB volume V_{EMB}_{ₜₒₜ} is simply

$${V}_{{EMB}_{tot}} = {n}_{{EMB}_{tot}} * {V}_{1 EMB} = ϕ V \qquad ( Eq . 12 )$$

where V_{1EMB} is the volume of a single EMB and V is the overall sample volume. In this case, since V_{IEMB},ϕ, and V are known quantities this expression would give a simple way of determining n_{EMB}_{ₜₒₜ}_{:n}_{_{EMB}}ₜₒₜ=ϕV/V_{1EMB}. However, not all EMBs in the samples have the same diameter, and so the measured distribution shown in FIG. 3 must be taken into account in determining n_{EMB}_{ₜₒₜ}. In a similar manner, n_{EMB}_{ₜₒₜ} is computed through

$${n}_{{EMB}_{tot}} = \frac{ϕ V}{{\int }_{{D}_{1}}^{{D}_{2}} {dD}_{O} ( Gaussian distribution ( {D}_{O} ) ) {V}_{1 EMB} ( {D}_{O} )} \qquad ( Eq . 13 )$$

where the upper and lower integral limits are taken to be D₁=1 μm and D₂=140 μm (corresponding to the lower and upper ranges of the measured EMB size distribution), and V_{1EMB}(D_{O})=(πD_{O}³)/6. With n_{EMB}_{ₜₒₜ} known, one can then compute n_{EMB}(D_{O}) and therefore n_{EMB}(f_{O}) using the above expressions and relationship between D_{O} and f_{O}, which gives the number of EMBs at each f_{O} for a given value of ϕ.

To compute the density of states n_{ω} (i.e., the EMB density per Hz), divide n_{EMB}(f_{O}) by the factor 2πV(df_{O}) (i.e., n_{ω}=n_{EMB}(f_{O})/(2πV(df_{O}))) where the quantity df_{O} is computed by determining df_{O}/dR_{O} from Eq. 3, which yields

$$( Eq . 14 )$$

$$\frac{{df}_{O}}{{dR}_{O}} = \frac{1}{4 π} {( \frac{3 {R}_{O} γ P + 12 {G}_{S} ε}{{R}_{O}^{2} [ {R}_{O} {ρ}_{l} + ε ( {ρ}_{S} - 3 {ρ}_{l} ) ]} )}^{- 1 / 2} [ \frac{3 γ P}{{R}_{O}^{2} [ {R}_{O} {ρ}_{l} + ε ( {ρ}_{S} - 3 {ρ}_{l} ) ]} - \frac{( 3 {R}_{O} γ P + 12 {G}_{S} ε )}{{( {R}_{O}^{2} [ {R}_{O} {ρ}_{l} + ε ( {ρ}_{S} - 3 {ρ}_{l} ) ] )}^{2}} [ 2 {R}_{O} ( {R}_{O} {ρ}_{l} + ε ( {ρ}_{S} - 3 {ρ}_{l} ) ) + {R}_{O}^{2} {ρ}_{l} ] ]$$

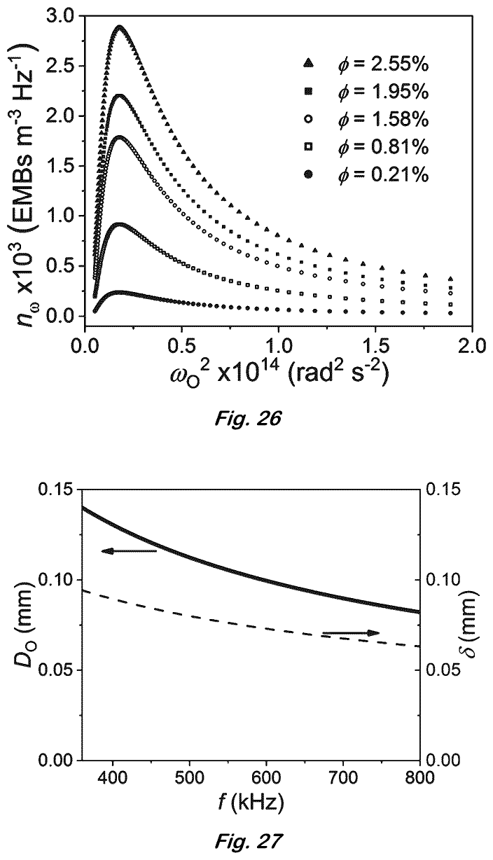

Upon computing df_{O}/dR_{O}, multiply by dR_{O} in order to find df_{O}, where dR_{O}=10 μm is from the measured EMB count versus D_{O} distribution bin size where the uncertainty in the EMB radius is ±5 microns, which gives a total dR_{O}=10 μm. FIG. 26 shows the density of states n_{ω} versus resonance angular frequency ω_{O} μsquared for multiple EMB equilibrium volume fractions ϕ for which data is presented. In these experiments, n_{ω} versus ω_{O}² is a one-sided, non-Gaussian distribution, which peaks at f=674 kHz. That the stiffness K=mω_{O}² where m is the oscillator mass (which varies weakly across the distribution) implies n_{ω} versus K is also non-Gaussian.

The density of active oscillators ρ_{active} (EMBs m⁻³) contributing to the scattering at each frequency f can be found from the expression

$${ρ}_{active} ( f ) = 2 {β}_{AR} {n}_{ω} = 2 π ( {df}_{O} ) {n}_{ω} \qquad ( Eq . 15 )$$

where β_{AR} is the acoustic radiation damping factor given by Eq. 5 and the quantity 2β_{AR} corresponds to the full-width at half-maximum of the scattering cross section (as exemplified by FIG. 5). FIG. 11 shows a representative plot of ρ_{active} versus f for ϕ=0.21%, which highlights how the number of EMBs contributing to the scattering in the samples (i.e., the disorder strength) increases with increasing frequency.

### Note 3—Measured Change in Phase Angle, Longitudinal Phase Velocity, Effective Wavelength, and Scattering Mean Free Path

The longitudinal phase velocity v_{L}, determined from the coherent part of the transmitted wave, is found from the change in phase angle Δθ as a function of f (see FIGS. 15 and 17) where the phase spectrum is extracted from the transfer function of the fast Fourier transforms for the sample and water reference data sets. Values for v_{L} are determined from v_{L}=L/((L/v_{w})−[(1/2π)(Δθ/Δf)]) where L is the material thickness and v_{w}=1492 m/s the water sound speed. It is determined that v_{L}=1,480 m/s±10 m/s for the 4 mm-thick Uralite, v_{L}=1498 m/s±5 m/s for the undoped gel sample (both the Uralite and Carbopol 2050 gel are closely impedance-matched to water), v_{L}=1306 m/s±7 m/s (f<660 kHz) and v_{L}=1398 m/s±14 m/s (f>660 kHz) for the sample with ϕ=0.21%, v_{L}=1,052 m/s±5 m/s (f<702 kHz), v_{L}=670 m/s±7 m/s (702 kHz<f<759 kHz), and v_{L}=444 m/s±9 m/s (f>759 kHz) for the sample with ϕ=0.81%, v_{L}=874 m/s±4 m/s (f<700 kHz) and v_{L}=398 m/s±3 m/s (f>700 kHz) for the sample with ϕ=1.58%, v_{L}=742 m/s±4 m/s (f<665 kHz) and v_{L}=307 m/s±6 m/s (f>665 kHz) for the sample with ϕ=1.95%, and v_{L}=791 m/s±5 m/s (f<554 kHz) and v_{L}=427 m/s±2 m/s (f>554 kHz) for the sample with ϕ=2.55%. These v_{L} values are for individual speckles, and a measure of the spread in v_{L} across speckles is shown in FIGS. 18 and 19. From measurements of v_{L}, compute λ using the standard expression λ=v_{L}/f.

Additionally, l_{S} decreases with increasing f across the range of EMB resonance frequencies targeted by the experiments (specifically, 360-800 kHz) to values considerably less than the doped gel thickness L_{G}=10 mm. As an example, at the frequencies where l_{S}/λ=1 for ϕ=0.21% and 0.81% (661 kHz and 577 kHz for ϕ=0.21%, and 0.81%, respectively), the measured values are l_{S}=1.57 mm and l_{S}=1.47 mm for ϕ=0.21%, and 0.81%, respectively.

### Note 4—Viscous Penetration Depth and the Biot Theory for Long-Wavelength Sound Propagation

For 360-800 kHz, the viscous penetration depth δ is always less than the EMB equilibrium diameter D_{O} where δ=(2η/ωρₗ)^{1/2} and η and ρₗ are the gel viscosity and density, respectively, and ω=2πf is the angular frequency. For a pH neutral Carbopol ETD 2050 gel (the suspending gel used in these experiments) the viscosity is expected to be η˜10,000 mPa*s based upon the material's Technical Data Sheet, and this q value was adopted in the determination of δ. FIG. 27 shows the frequency spectra for the EMB equilibrium diameter D_{O} and the viscous penetration depth δ. That δ is always less than D_{O} across the full frequency range of interest suggests δ is not an order parameter for the transition into the quasi-gaseous phase as described herein.

Because δ is always less than D_{O} the Biot theory can be ruled out for long-wavelength sound propagation in a porous medium [48, 49], which considers mode decoupling and sound propagation primarily through the inhomogeneous fluid when δ becomes less than the pore size: the Biot theory cannot explain an abrupt decrease in v_{L} at f_{C}* because δ was not observed to become less than a critical parameter at this frequency.

### Note 5—Effective Volume Fraction

In determining the effective volume fraction, first determine the range of f and ϕ over which the independent scattering approximation (ISA) is valid. For weakly disordered/scattering systems the perturbative expression for the inverse mean free path l⁻¹(ω)≈Σ_{κ}n_{κ}σ_{κ}(ω) (with κ designating the scatterer type, n_{κ} the scatterer density (scatterers per volume per frequency), and σ_{κ}(ω) the single scatterer cross section) leads to the association of attenuation resonances with single scatterer (Mie) resonances of type κ[50]. For simplicity, treat scatterers having different resonance frequencies as different scatterer types κ, assume the resulting scatterer types represent distinct scattering channels, and ignore any interference effects between the channels. The EMB-doped system is different from Ref. 50 because the scatterer label κ is itself smooth and labels the scatterer frequency.

The angular frequency dependence of the inverse mean free path l⁻¹ (ω) is derived by expressing the sum over the smooth index κ, which labels the EMB scatterer frequency, as the following integral

$${l}^{- 1} ( ω ) \approx {\sum }_{κ} {n}_{κ} {σ}_{κ} ( ω ) \approx {\int }_{0}^{∞} d {ω}_{O} {n}_{ω O} {σ}_{ω O} ( ω ) \qquad ( Eq . 16 )$$

where n_{ωO} has units of EMBs/(m³ Hz) and coo is the resonance angular frequency. Using the form of σ(ω) provided in Note 1 (Eq. 4), the integral can be written as

$${l}^{- 1} ( ω ) \approx {σ}_{ω O} {ω}^{4} {\int }_{0}^{∞} d {ω}_{O} \frac{{n}_{ω O}}{{( {ω}^{2} - {ω}_{O}^{2} )}^{2} + {( 2 β ω )}^{2}} \qquad ( Eq . 17 )$$

where β is the radiative damping factor and σ_{ωO}=4πR₁₀²(ρₗ²/(ρ_{S}²a²)) where a=[1+((ρₗ−ρ_{S})/ρ_{S})R₁₀/R₂₀], ρₗ and ρ_{S} are the suspending gel and EMB shell densities, respectively, and R₁₀ and R₂₀ are the inner and outer EMB equilibrium radii, respectively. Rearranging the integral's denominator and factoring out an ω² from each term in square brackets yields

$${l}^{- 1} ( ω ) \approx {σ}_{ω O} {\int }_{0}^{∞} d {ω}_{O} \frac{{n}_{ω O}}{[ ( 1 - \frac{{ω}_{O}^{2}}{{ω}^{2}} ) + \frac{i 2 β}{ω} ] [ ( 1 - \frac{{ω}_{O}^{2}}{{ω}^{2}} ) - \frac{i 2 β}{ω} ]} \qquad ( Eq . 18 )$$

Making the substitution y=ω_{O}²/ω², and for the resonance condition ω=ω_{O}, the integral becomes

$${l}^{- 1} ( ω ) \approx \frac{{σ}_{ω O}}{2} ω {\int }_{0}^{∞} dy \frac{{n}_{ω O}}{[ ( 1 - y ) + \frac{i 2 β}{ω} ] [ ( 1 - y ) - \frac{i 2 β}{ω} ]} \qquad ( Eq . 19 )$$

By assuming negligible contribution to the integral for −∞<y<0 one can extend the limits of integration to ±∞ and integrate over the complex plane, which yields the expression

$${l}^{- 1} ( ω ) \approx π {n}_{ω} {σ}_{ω O} {ω}^{2} / ( 4 β ) \qquad ( Eq . 20 )$$

where the quantity n_{ω} has been found by evaluating n_{Oω} at ω.

In computing l⁻¹(ω), β is dominated by acoustic radiation damping with the damping coefficient β_{AR} provided in Note 1 (Eq. 5). Values for σ_{ωO} are computed knowing R₁₀ and R₂₀ as a function of frequency, which is determined by solving the cubic equation (Eq. 9) discussed in Note 1 that considers all terms to first order in EMB shell thickness ε. The density of states n_{ω} is determined by those procedures described in Note 2.

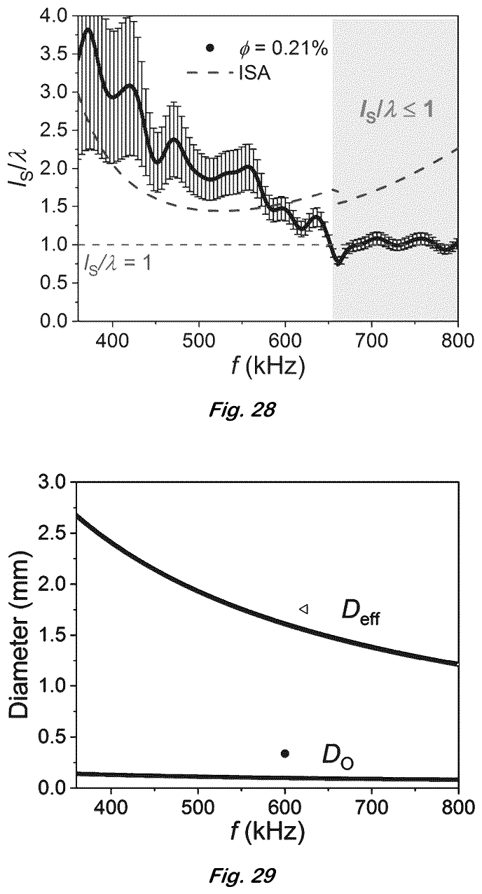

The upper dashed line in FIG. 28 is an ISA l(f)/λ prediction where l(f) is computed with Eq. 20 and λ is determined from the measured v_{L}. The ISA functional form only qualitatively agrees with the ϕ=0.21% data up to f=600 kHz, and for f>600 kHz and for higher ϕ the ISA no longer agrees qualitatively with the measured l_{S}/λ functional form; note, the small decrease in the ISA prediction for l(f)/λ at f_{C}=661 kHz seen in FIG. 28 is due to a measured increase in v_{L} at this frequency, which effects both λ and β_{AR}. The failure of the ISA to explain the data indicates significant multiple scattering occurs in the samples and that the ISA is largely inapplicable to this system (because the scatterers are resonant with effective size of order λ). Scattering in the samples is governed by on-resonance effective properties and samples with similar ϕ can have quite different effective volume fractions.

The frequency-dependent EMB on-resonance effective volume fraction ϕ_{eff}(f) is related to the density of states n_{ω} by

$${ϕ}_{eff} ( f ) = ( π / 6 ) [ {n}_{ω} * Δ ω ] {( {D}_{eff} ( f ) )}^{3} \qquad ( Eq . 21 )$$

where the quantity in square brackets represents the density of active (resonating) EMBs at frequency f=ω/2π (see Note 2). The quantity D_{eff} is determined from σ_{eff}(f)=πR_{eff}² knowing D_{O} versus ω_{O} and computing σ_{eff}(f) on resonance and accounting for acoustic radiation damping.

Note, at a given frequency, the effective scattering cross section is the result of scattering by the total number of active oscillators within the cross section peak width. Thus, to account for a finite σ_{eff}(f) peak width in the computations of D_{eff} the average effective scattering cross section σ_{eff_AVG}(J) is determined and then from σ_{eff_AVG}(f) an average effective diameter D_{eff_AVG}(f) is computed. Integrating over the total scattering cross section in the effective medium (using the measured wave speed, as opposed to the undoped gel wave speed) gives

$${σ}_{eff \_ AVG} ( f ) = \frac{1}{Δ ω} {\int }_{ω - Δ ω / 2}^{ω + Δ ω / 2} {σ}_{eff} ( ω ) d ω = \frac{π}{16 {ω}_{O}^{2} {β}_{AR}^{2}} \qquad ( Eq . 22 )$$

which yields σ_{eff}(f)/σ_{ff_AVG}(f)=4/ π, and subsequently D_{eff_AVG}(g)=[σ_{eff}(f)]^{1/2}. Values for D_{eff_AVG}(f) are used to determine the effective volume fraction ϕ_{eff}.

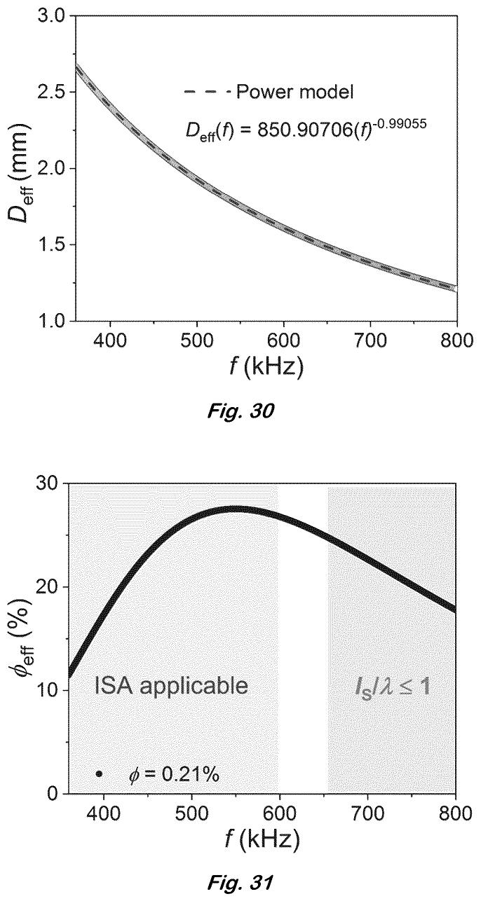

The predictions shown in FIG. 29 highlight that for a single EMB on resonance D_{eff} is significantly larger than D_{O} (between a factor of 15 and 19 greater depending upon the frequency). The predictions shown in FIG. 30 highlight that in this case D_{eff}∝1/f. Lastly, FIG. 31 shows that within the range of f over which the ISA is applicable, ϕ_{eff} varies considerably (from 11.5% up to 27.5%), which explains how such effects are observable in the samples despite the low (a few percent) EMB equilibrium volume fractions. Also, the peak in ϕ_{eff} versus f near f=550 kHz is the result of an increasing EMB density of active oscillators ρ_{active}(f) and simultaneous decrease in D_{eff}(f) with increasing frequency.

### Note 6—Reflection Frequency Spectra, Monopole Scattering of Longitudinal Waves, Incoherent Wave Data, Additional SCT Analysis, and Absorption

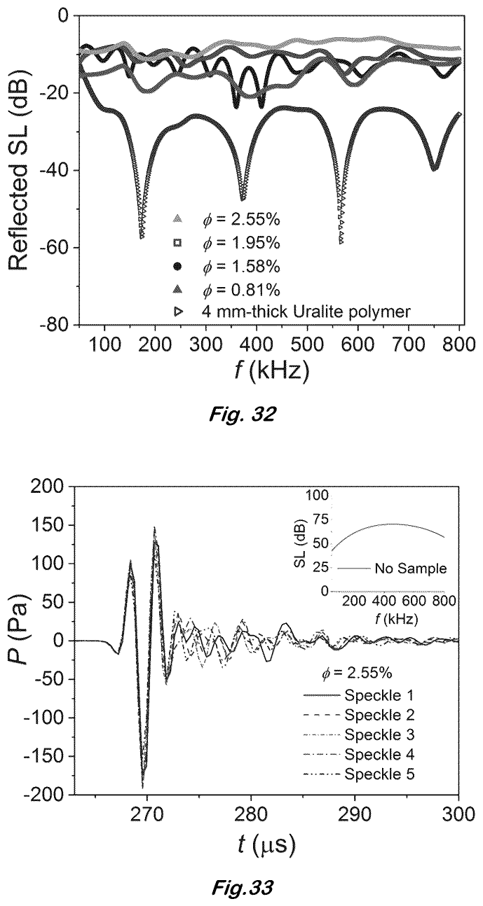

FIG. 32 shows the measured reflected sound level (SL) versus f for a 4 mm-thick undoped Uralite sample and for four doped samples with ϕ=0.81%, ϕ=1.58%, ϕ=1.95%, and ϕ=2.55%; note, the thickness of the Uralite sample was chosen to match the thickness of the walls of the Uralite shell into which the doped gel is poured for the in-water measurements. The SL minima observed in FIG. 32 are explained in terms of thickness modes where the effective wavelength becomes comparable to the material thickness, which results in a measured drop in the reflected SL at this condition. Despite the thickness modes, the overall maximum reflected SL for each sample is fairly constant across the entire experimental frequency range including those frequencies at which there are no resonating EMBs (50-360 kHz). No evidence of resonant reflection was observed across the entire frequency range of interest including at f(l_{S}/λ=1),f_{C}*, and for those frequencies where l_{S}/λ<1 is satisfied. Also, internal reflectivity is weak and should not skew late-time analysis because the ratio of the penetration depth z_{O} to L_{G} can be an order of magnitude less than unity: for example, atf=577 kHz for ϕ=0.81%, z_{O}=(2l_{S}[1+Rᵣ])/(3[1−Rᵣ])=1.2 mm where l_{S}=1.47 mm and Rᵣ is the internal reflectivity [51] estimated by averaging over the reflected sound level.

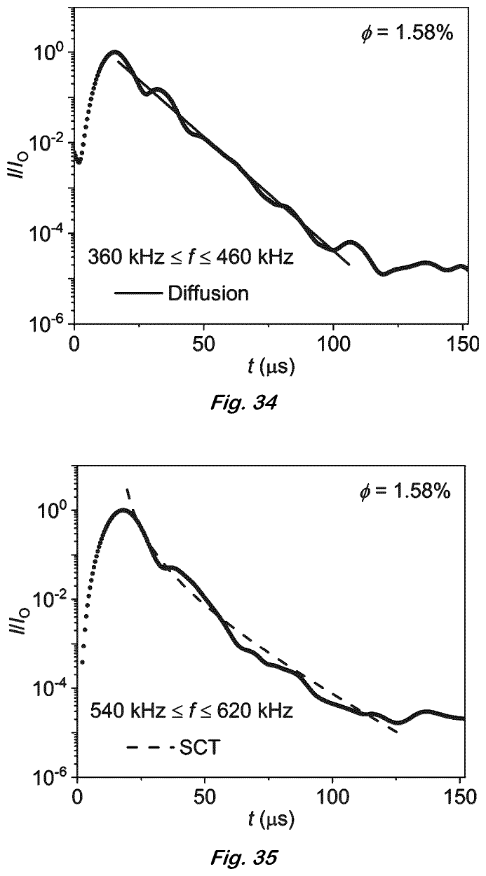

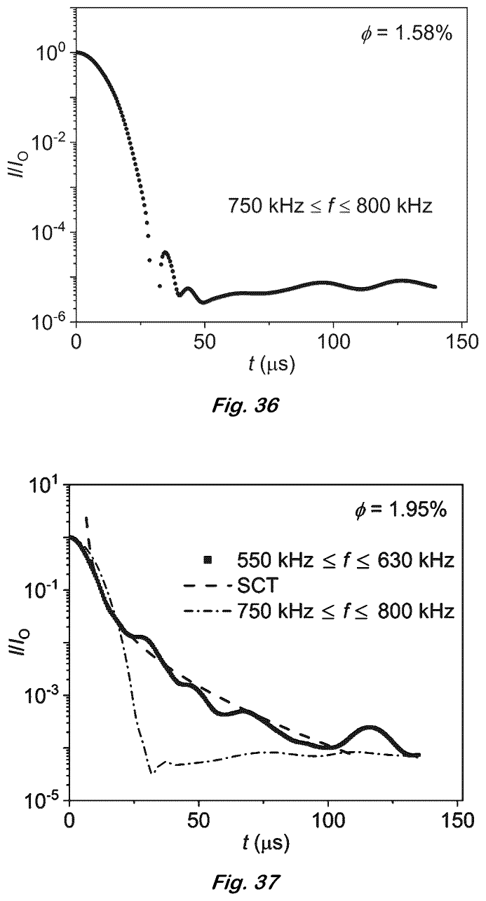

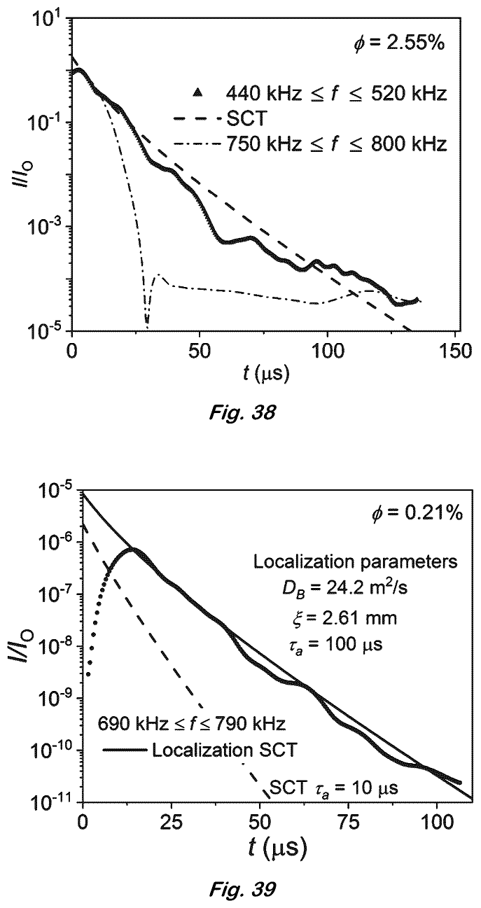

It is known from first principles that monopole scattering of longitudinal waves (expected in this system) does not create shear waves [52], and so slow shear waves are not expected to skew late-time analysis of the incoherent energy. Even if near fields create higher-order multipole scattering, the coupling of longitudinal wave to shear wave is weak leading to an intensity reduction of order 10⁻⁴, and since wave energy must subsequently be converted back into longitudinal waves to be observed an additional suppression of 10⁻⁴ is incurred; this is the result of the disparate wave speeds in the system (of order 1000 m/s for longitudinal waves and of order 10 m/s for shear waves). Thus, such effects are expected to be negligible. Further, if shear waves were nevertheless generated by some unknown mechanism with appreciable amplitudes in the system (despite the fluid-like nature of the system), then they might be expected to be generated at all frequencies, even for frequencies where diffusive effects (exponential decay of I/I_{O} vs. t where I/I_{O} is the normalized intensity for the incoherent field and t is the time) are observed and for the quasi-gaseous phase (where the density of active oscillators is high) where no incoherent energy is measured above the experiment's noise floor. However, across samples, no late-time deviation from linearity is found when diffusive effects are measured (see FIG. 34 for an example) or in the quasi-gaseous phase (750-800 kHz in FIGS. 36-38), which supports no late-time component due to a shear wave.

To study late-time behavior of the transmitted incoherent energy a narrow impulse with width Δt<10 μs is used. FIG. 33 shows an example of measured pressure P versus t for ϕ=2.55% across speckles. The coherent field (266 μs<t<272 μs) was found to be speckle independent. However, a strong incoherent field is observed for t>272 μs, which varies across speckles and shows temporal fluctuations that vary on a time scale corresponding to the input wavepacket. Such fluctuations are the result of wave interference along multiple scattering paths [51, 53, 54].

FIG. 34 exemplifies how I/I_{O} on a semi-logarithmic plot follows a linear time dependence for f<f(at l_{S}/λ=1), which indicates diffusive wave propagation. Classically, at late times I/I_{O}=e^{-t/τ}^{_{D}} where τ_{D}⁻¹ is the lowest eigenvalue of the diffusion operator −DV² [55]. FIG. 34 data agrees with the diffusion model, and TD=8.6 μs±0.5 μs is obtained, which yields D*=L_{G}²/(π²τ_{D})=1.18 m²/s±0.07 m²/s (L_{G}=10 mm is the doped gel thickness) and a diffusion length l_{D}=(D*τ_{D})^{1/2}=3.2 mm. Here, l_{D} is over a factor of 3 μsmaller than L_{G}. Additionally, it is confirmed that changing the frequency range within the diffusive regime (f<f(at l_{S}/λ=1)) leads only to linear I/I_{O} versus t behavior.

FIGS. 35, 37, and 38 solid symbol data sets show for f(at l_{S}/λ=1)<f<f_{C}*, corresponding to the range of f and ϕ where l_{S}/λ<1. Deviations are found from diffusion at late times that are well-fitted by the phenomenological self-consistent theory (SCT) of localization [56]: in a localized phase the average transmission coefficient T(t)˜e^{-ηt}/t^{P+1} where η=(D_{B}/ξ²)exp(−L_{G}/ξ), D_{B} is the bare diffusion coefficient, and ξ the localization length. The restriction 0.5≤p≤1.0 yields ξ=2.41 mm, 2.35 mm, and 2.18 mm for ϕ=1.58%, 1.95%, and 2.55%, respectively (more than a factor of 4 μsmaller than L_{G}). Also, in fittings to the SCT, the bare diffusion coefficient D_{B} serves as a free-fitting parameter, and it was determined D_{B}=18.1 m²/s, 10.1 m²/s, and 23.4 m²/s for ϕ=1.58%, 1.95%, and 2.55%, respectively; these large D_{B} values are inconsistent with the measured D*, but are consistent with prior studies on EMB-doped gel [43] and sound localization in mesoglasses [57].

FIGS. 36-38 show results for f>f_{C}*; specifically, for 750-800 kHz, which corresponds to frequencies where a v_{L} reduction was measured, l_{S}/λ>1, and the quasi-gaseous phase as described. Accounting for a 20 μs uncertainty for the 50 kHz digital filter applied to study the quasi-gaseous phase data, the data in FIGS. 36-38 shows no late-time evidence for diffusive or localized states for f>f_{C}* above the experiment's noise floor.

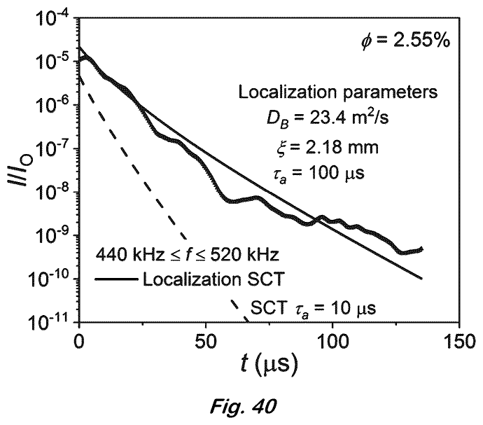

Absorption is not expected to skew the late-time analysis because the characteristic absorption time τₐ≥100 μs is an order of magnitude larger than τ_{D} (which is found by multiplying T(t) within the SCT by the factor e^{-t/τ}^{ₐ}). Further, taking τₐ˜τ_{D}=10 μs cannot account for the observed late-time deviations from linearity, and this is demonstrated by the dashed purple lines in FIGS. 39 and 40 for representative ϕ values. It is concluded that absorption is unimportant in these measurements. Further, f_{O}=800 kHz (the maximum frequency in these experiments) corresponds to a resonating EMB with D_{O}=82 μm, which is near the maximum in the EMB size distribution shown in FIG. 3. Yet, despite the continuous increase in the density of active oscillators with increasing frequency the loss of the incoherent signal for f>f_{C}* further supports the conclusion that absorption does not skew the late-time analysis since one would expect an increasing scatterer density might lead to higher absorption levels and persistent linear late-time behavior (which is not observed experimentally).

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

### REFERENCES

1. Brunet, T. et al. Soft 3D acoustic metamaterial with negative index. Nature Mater. 14, 384-388 (2015).
2. Matis, B. R. et al. Critical role of a nanometer-scale microballoon shell on bulk acoustic properties of doped soft matter. Langmuir 36, 5787-5792 (2020).
3. Ba, A., Kovalenko, A., Aristégui, C., Mondain-Monval, O. & Brunet, T. Soft porous silicone rubbers with ultra-low sound speeds in acoustic metamaterials. Sci. Rep. 7, 40106 (2017).
4. Ates, H. C. et al. End-to-end design of wearable sensors. Nat. Rev. Mater. 7, 887-907 (2002).
5. Sempionatto, J. R., Lasalde-Ramírez, J. A., Mahato, K., Wang, J. & Gao, W. Wearable chemical sensors for biomarker discovery in the omics era. Nat. Rev. Chem. 6, 899-915 (2022).
6. Lin, M., Hu, H., Zhou, S. & Xu, S. Soft wearable devices for deep-tissue sensing. Nat. Rev. Mater. 7, 850-869 (2022).
7. Brotchie, A. Medical devices: soft micromachines run like clockwork. Nat. Rev. Mater. 2, 17002 (2017).
8. Chin, S. Y. et al. Additive manufacturing of hydrogel-based materials for next-generation implantable medical devices. Sci. Robot. 2, eaah6451 (2017). DOI:10.1126/scirobotics.aah6451
9. Ji, Q. et al. 4D thermomechanical metamaterials for soft microrobotics. Commun. Mater. 2, 93 (2021).
10. Hu, H. et al. A wearable cardiac ultrasound imager. Nature 613, 667-675 (2023).
11. Hu, H. et al., Stretchable ultrasonic arrays for the three-dimensional mapping of the modulus of deep tissue. Nat. Biomed. Eng. 7, 1321-1334 (2023).
12. Kaya, K., Iseri, E. & van der Wijngaart, W. Soft metamaterial with programmable ferromagnetism. Microsyst. Nanoeng. 8, 127 (2022).
13. Li, S., Zhao, D., Niu, H., Zhu, X. & Zang, J. Observation of elastic topological states in soft materials. Nat. Commun. 9, 1370 (2018).
14. El Helou, C., Buskohl, P. R., Tabor, C. E. & Harne, R. L. Digital logic gates in soft, conductive mechanical metamaterials. Nat. Commun. 12, 1633 (2021).
15. Brunet, T. et al. Sharp acoustic multipolar-resonances in highly monodisperse emulsions. Appl. Phys. Lett. 101, 011913 (2012).
16. Tallon, B., Brunet, T. & Page, J. H. Impact of strong scattering resonances on ballistic and diffusive wave transport. Phys. Rev. Lett. 119, 164301 (2017).
17. Matis, B. R. et al. Observation of a transition to a localized ultrasonic phase in soft matter. Commun. Phys. 5, 21 (2022).
18. Pierre, J., Dollet, B. & Leroy, V. Resonant acoustic propagation and negative density in liquid foams. Phys. Rev. Lett. 112, 148307 (2014).
19. Song, Y. et al. Thermal- and pH-responsive triple-shape memory hydrogel based on a single reversible switch. Soft Matter 19, 5244-5248 (2023).
20. Suzuki, A. & Tanaka, T. Phase transition in polymer gels induced by visible light. Nature 346, 345-347 (1990).
21. Tournat, V., Pagneux, V., Lafarge, D. & Jaouen, L. Multiple scattering of acoustic waves and porous absorbing media. Phys. Rev. E 70, 026609 (2004).
22. Kinsler, L. E., Frey, A. R., Coppens, A. B. & Sanders, J. V. Fundamentals of Acoustics (John Wiley & Sons, Inc., 1982), p. 160-162.
23. Liu, J., Ye, L., Weitz, D. A. & Sheng, P. Novel acoustic excitations in suspensions of hard-sphere colloids. Phys. Rev. Lett. 65, 2602-2605 (1990).
24. Biot, M. A. Theory of propagation of elastic waves in a fluid-saturated porous solid. I. low-frequency range. J. Acoust. Soc. Am. 28, 168-178 (1956).
25. Biot, M. A. Theory of propagation of elastic waves in a fluid-saturated porous solid. II. Higher frequency range. J. Acoust. Soc. Am. 28, 179-191 (1956).
26. Liu, Q., Feng, X., Zhang, K., An, B. & Duan, Y. Vapor pressure and gaseous speed of sound measurements for isobutane (R600a). Fluid Ph. Equilibria 382, 260-269 (2014).
27. Tanaka, T. et al. Phase transitions in ionic gels. Phys. Rev. Lett. 45, 1636-1639 (1980).
28. Tanaka, T. et al. Mechanical instability of gels at the phase transition. Nature 325, 796-798 (1987).
29. Hirokawa, Y., Tanaka, T. & Sato, E. Phase transition of positively ionized gels. Macromolecules 18, 12, 2782-2784 (1985).
30. Takeoka, Y. et al. First order phase transition and evidence for frustrations in polyampholytic gels. Phys. Rev. Lett. 82, 4863-4865 (1999).
31. Amiya, T. & Tanaka, T. Phase transitions in crosslinked gels of natural polymers. Macromolecules 20, 1162-1164 (1987).
32. Kinsler, L. E., Frey, A. R., Coppens, A. B. & Sanders, J. V. Fundamentals of Acoustics (John Wiley & Sons, Inc., 1982), p. 100-110.
33. Kirkpatrick, S. Percolation and conduction. Rev. Mod. Phys. 45, 574-588 (1973).
34. Anderson, P. W. Absence of diffusion in certain random lattices. Phys. Rev. 109, 1492-1505 (1958).
35. Louisnard, O. A simple model of ultrasound propagation in a cavitating liquid. Part I: theory, nonlinear attenuation and traveling wave generation. Ultrason. Sonochem. 19, 56-65 (2012).
36. Sojahrood, A. J. et al. Probing the pressure dependence of sound speed and attenuation in bubbly media: Experimental observations, a theoretical model and numerical calculations. Ultrason. Sonochem. 95, 106319 (2023).
37. Commander, K. W. & Prosperetti, A. Linear pressure waves in bubbly liquids: Comparison between theory and experiments. J. Acoust. Soc. Am. 85, 732-746 (1989).
38. Sojahrood, A. J., Haghi, H., Karshafian, R., & Kolios, M. C. Nonlinear model of acoustical attenuation and speed of sound in a bubbly medium. in: 2015 IEEE International Ultrasonics Symposium (IUS), IEEE, 2015. doi: 10.1109/ULTSYM.2015.0086.
39. Kinsler, L. E., Frey, A. R., Coppens, A. B. & Sanders, J. V. Fundamentals of Acoustics (John Wiley & Sons, Inc., 1982), p. 228.
40. Leroy, V., Strybulevych, A., Page, J. H. & Scanlon, M. G. Sound velocity and attenuation in bubbly gels measured by transmission experiments. J. Acoust. Soc. Am. 123, 1931-1940 (2008).
41. Kinsler, L. E., Frey, A. R., Coppens, A. B. & Sanders, J. V. Fundamentals of Acoustics (John Wiley & Sons, Inc., 1982), p. 107.
42. Chen, J., Hunter, K. S., & Shandas, R. Wave scattering from encapsulated microbubbles subject to high-frequency ultrasound: contribution of higher-order scattering modes. J. Acoust. Soc. Am. 126, 1766-1775 (2009).
43. Matis, B. R. et al. Observation of a transition to a localized ultrasonic phase in soft matter. Commun. Phys. 5, 21 (2022)
44. Matis, B. R. et al. Critical role of a nanometer-scale microballoon shell on bulk acoustic properties of doped soft matter. Langmuir 36, 5787-5792 (2020).
45. Kinsler, L. E., Frey, A. R., Coppens, A. B. & Sanders, J. V. Fundamentals of Acoustics (John Wiley & Sons, Inc., 1982), p. 228.
46. Tan, L., Pan, J. & Wan, A. Shear and extensional rheology of polyacrylonitrile solution: effect of ultrahigh molecular weight polyacrylonitrile. Colloid Polym. Sci. 290, 289-295 (2012).
47. Khismatullin, D. B. & Nadim, A. Radial oscillations of encapsulated microbubbles in viscoelastic liquids. Phys. Fluids 14, 3534-3557 (2002)
48. Biot, M. A. Theory of propagation of elastic waves in a fluid-saturated porous solid. I. low-frequency range. J. Acoust. Soc. Am. 28, 168-178 (1956).
49. Biot, M. A. Theory of propagation of elastic waves in a fluid-saturated porous solid. II. Higher frequency range. J. Acoust. Soc. Am. 28, 179-191 (1956).
50. Tallon, B., Brunet, T. & Page, J. H. Impact of strong scattering resonances on ballistic and diffusive wave transport. Phys. Rev. Lett. 119, 164301 (2017).
51. Page, J. H., Schriemer, H. P., Bailey, A. E. & Weitz, D. A. Experimental test of the diffusion approximation for multiply scattered sound. Phys. Rev. E 52, 3106-3114 (1995).
52. Korneev, V. A. & Johnson, L. R. Scattering of P and S waves by a spherically symmetric inclusion. Pure and Appl. Geophys. 147, 675-718 (1996).
53. Rimberg, A. J. & Westervelt, R. M. Temporal fluctuations of multiply scattered light in a random medium. Phys. Rev. B 38, 5073(R) (1988).
54. Stephen, M. J. Temporal fluctuations in wave propagation in random media. Phys. Rev. B 37, 1-5 (1988).
55. Mirlin, A. D. Statistics of energy levels and eigenfunctions in disordered systems. Phys. Rep. 326, 259-382 (2000).
56. Skipetrov, S. E. & van Tiggelen, B. A. Dynamics of Anderson localization in open 3D media. Phys. Rev. Lett. 96, 043902 (2006).
57. Hu, H., Strybulevych, A., Page, J. H., Skipetrov, S. E. & van Tiggelen, B. A. Localization of ultrasound in a three-dimensional elastic network. Nat. Phys. 4, 945-948 (2008).

What is claimed is:

1. A composition comprising:
a soft material having a shear modulus and a bulk modulus larger than the shear modulus; and
a plurality of encapsulated microbubbles within the soft material;
wherein the composition exhibits a discontinuous change in an acoustic property relative to an applied frequency.

2. The composition of claim 1, wherein the acoustic property is phase angle or longitudinal phase velocity.

3. The composition of claim 1, wherein the soft material is a suspending gel.

4. The composition of claim 1, wherein the bulk modulus is at least 100 times the shear modulus.

5. The composition of claim 1, wherein each of the encapsulated microbubbles comprises:
a polyacrylonitrile shell; and
a gas within the shell.

6. The composition of claim 1, wherein the encapsulated microbubbles range in diameter from 1 micron to 150 microns.

7. The composition of claim 1, wherein the encapsulated microbubbles have an average diameter from 60 microns to 140 microns.

8. The composition of claim 1, wherein the encapsulated microbubbles have a diameter distribution from D(0.4) to D(0.6).

9. The composition of claim 1, wherein the composition comprises an encapsulated microbubble equilibrium volume fraction from 0.8% to 10%.
